(19) United States
(12) Patent Application Publication
(10) Pub. No.: US 2024/0340900 A1
(43) Pub. Date: Oct. 10, 2024

(54) DOWNLINK PREEMPTION PATTERN INDICATION SIGNALING

(71) Applicant: QUALCOMM Incorporated, San Diego, CA (US)

(72) Inventors: Qian Zhang, Basking Ridge, NJ (US); Yan Zhou, San Diego, CA (US); Muhammad Sayed Khairy Abdelghaffar, San Jose, CA (US)

(21) Appl. No.: 18/296,034

(22) Filed: Apr. 5, 2023

(51) Int. Cl. H04W 72/20; H04W 72/12

(52) U.S. Cl. CPC H04W 72/20; H04W 72/12

(57) ABSTRACT

Methods, systems, and devices for wireless communications are described. The described techniques provide for a victim network entity to share a downlink preemption pattern with user equipments (UEs) and neighboring network entities. For example, the victim network entity may transmit, to a UE and/or a neighbor network entity, control signaling indicating a recurring downlink preemption pattern defining one or more resources during which the UE may preempt reception of downlink signaling and the victim and neighbor network entities may preempt transmission of downlink signaling. The UE and the network entities may refrain from monitoring for downlink transmissions and transmitting downlink transmissions, respectively, in accordance with the indicated downlink preemption pattern. In some examples, the UE and the network entities may be configured with one or more conditions for discarding the indicated downlink preemption pattern and monitoring the one or more resources for or transmitting downlink transmissions.

### TECHNICAL FIELD

The following relates generally to wireless communications, and more specifically to downlink preemption pattern indication signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support downlink preemption pattern indication signaling. For example, the described techniques provide for a victim network entity to share (e.g., transmit, indicate) a downlink preemption (e.g., muting) pattern with one or more user equipments (UEs), one or more neighboring network entities, or both. For example, the victim network entity may transmit, to a UE and/or a neighbor network entity, control signaling indicating a recurring (e.g., periodic or semi-persistent) downlink preemption pattern defining one or more resources (e.g., time and frequency resources) during which the UE may preempt reception of (e.g., not receive) downlink signaling and the victim and neighbor network entities may preempt transmission of (e.g., not transmit) downlink signaling. That is, the UE may refrain from monitoring for and the victim and neighbor network entities may refrain from transmitting downlink transmissions in accordance with the indicated downlink preemption pattern. The one or more resources may be associated with cross link interference (CLI) channel measurement. For example, the victim network entity may use the one or more resources to measure and estimate a CLI channel between the victim network entity and an aggressor network entity, and the preemption of downlink signaling in accordance with the downlink preemption pattern may reduce interference with and increase an accuracy of the CLI channel measurement. In some examples, the UE and the victim and neighbor network entities may be configured with one or more conditions (e.g., power thresholds, transmission priorities, among others) for discarding the indicated downlink preemption pattern and monitoring the one or more resources for downlink transmissions or transmitting downlink transmissions, respectively.

A method for wireless communication at a UE is described. The method may include receiving a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell and receiving one or more downlink transmissions based on the indication of the downlink preemption pattern.

An apparatus for wireless communication at a UE is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the UE to receive a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell and receive one or more downlink transmissions based on the indication of the downlink preemption pattern.

Another apparatus for wireless communication at a UE is described. The apparatus may include means for receiving a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell and means for receiving one or more downlink transmissions based on the indication of the downlink preemption pattern.

A non-transitory computer-readable medium storing code for wireless communication at a UE is described. The code may include instructions executable by at least one processor (e.g., directly, indirectly, after pre-processing, without pre-processing) to receive a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell and receive one or more downlink transmissions based on the indication of the downlink preemption pattern.

Some examples of the method, apparatuses, and non-transitory computer-readable medium described herein may further include operations, features, means, or instructions for receiving a second control message indicating a set of recurring downlink preemption patterns, where the recurring downlink preemption pattern may be indicated from the set of recurring downlink preemption patterns.

Some examples of the method, apparatuses, and non-transitory computer-readable medium described herein may further include operations, features, means, or instructions for canceling monitoring and receiving of downlink transmissions via the one or more time and frequency resources in accordance with the downlink preemption pattern.

In some examples of the method, apparatuses, and non-transitory computer-readable medium described herein, receiving the one or more downlink transmissions may include operations, features, means, or instructions for receiving, contrary to the downlink preemption pattern, the one or more downlink transmissions via the one or more time and frequency resources based on one or more parameters associated with the downlink transmissions satisfying one or more thresholds.

In some examples of the method, apparatuses, and non-transitory computer-readable medium described herein, the one or more parameters associated with the downlink transmissions include a priority associated with the one or more downlink transmissions, a latency constraint associated with the one or more downlink transmissions, a modulation and coding scheme (MCS) associated with the downlink transmissions, a transmission power associated with the downlink transmissions, or a combination thereof.

Some examples of the method, apparatuses, and non-transitory computer-readable medium described herein may further include operations, features, means, or instructions for receiving an indication of the one or more thresholds.

In some examples of the method, apparatuses, and non-transitory computer-readable medium described herein, receiving the one or more downlink transmissions may include operations, features, means, or instructions for receiving the one or more downlink transmissions via one or more second time and frequency resources excluded from the downlink preemption pattern.

In some examples of the method, apparatuses, and non-transitory computer-readable medium described herein, the recurring downlink preemption pattern applies to a set of types of downlink transmissions including at least synchronization signal block (SSB) messages.

In some examples of the method, apparatuses, and non-transitory computer-readable medium described herein, the set of types of downlink transmissions includes physical downlink shared channel (PDSCH) transmissions, physical downlink control channel (PDCCH) transmissions, channel state information reference signals (CSI-RSs), and semi-persistent scheduling (SPS) transmissions.

In some examples of the method, apparatuses, and non-transitory computer-readable medium described herein, the downlink preemption pattern indicates one or more subbands for which the downlink transmissions to the UE may be preempted, one or more resource elements (REs) for which the downlink transmissions to the UE may be preempted, or a frequency band including the one or more subbands or the one or more REs for which the downlink transmissions to the UE may be preempted, the one or more time and frequency resources included in the one or more subbands, the one or more REs, or the frequency band.

Some examples of the method, apparatuses, and non-transitory computer-readable medium described herein may further include operations, features, means, or instructions for receiving the control message includes receiving the control message via layer 2 (L2) signaling, layer 3 (L3) signaling, a medium access control-control element (MAC-CE), radio resource control (RRC) signaling, or downlink control information (DCI).

In some examples of the method, apparatuses, and non-transitory computer-readable medium described herein, the recurring downlink preemption pattern may be periodic or semi-persistent.

A method for wireless communication at a first network entity associated with a first cell is described. The method may include outputting a control message including an indication of a recurring downlink preemption pattern defining one or more time and frequency resources for which downlink transmissions to a UE are preempted, the one or more time and frequency resources associated with CLI channel measurement between the first network entity and a second network entity associated with a second cell and outputting one or more downlink transmissions to the UE based on the indication of the downlink preemption pattern.

An apparatus for wireless communication at a first network entity associated with a first cell is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the first network entity to output a control message including an indication of a recurring downlink preemption pattern defining one or more time and frequency resources for which downlink transmissions to a UE are preempted, the one or more time and frequency resources associated with CLI channel measurement between the first network entity and a second network entity associated with a second cell and output one or more downlink transmissions to the UE based on the indication of the downlink preemption pattern.

Another apparatus for wireless communication at a first network entity associated with a first cell is described. The apparatus may include means for outputting a control message including an indication of a recurring downlink preemption pattern defining one or more time and frequency resources for which downlink transmissions to a UE are preempted, the one or more time and frequency resources associated with CLI channel measurement between the first network entity and a second network entity associated with a second cell and means for outputting one or more downlink transmissions to the UE based on the indication of the downlink preemption pattern.

A non-transitory computer-readable medium storing code for wireless communication at a first network entity associated with a first cell is described. The code may include instructions executable by at least one processor (e.g., directly, indirectly, after pre-processing, without pre-processing) to output a control message including an indication of a recurring downlink preemption pattern defining one or more time and frequency resources for which downlink transmissions to a UE are preempted, the one or more time and frequency resources associated with CLI channel measurement between the first network entity and a second network entity associated with a second cell and output one or more downlink transmissions to the UE based on the indication of the downlink preemption pattern.

Some examples of the method, apparatuses, and non-transitory computer-readable medium described herein may further include operations, features, means, or instructions for outputting a second control message indicating a set of recurring downlink preemption patterns, where the recurring downlink preemption pattern may be indicated from the set of recurring downlink preemption patterns.

Some examples of the method, apparatuses, and non-transitory computer-readable medium described herein may further include operations, features, means, or instructions for canceling transmitting downlink signaling via the one or more time and frequency resources in accordance with the downlink preemption pattern.

In some examples of the method, apparatuses, and non-transitory computer-readable medium described herein, outputting the one or more downlink transmissions may include operations, features, means, or instructions for outputting, contrary to the downlink preemption pattern, the one or more downlink transmissions via the one or more time and frequency resources based on one or more parameters associated with the downlink transmissions satisfying one or more thresholds.

In some examples of the method, apparatuses, and non-transitory computer-readable medium described herein, the one or more parameters associated with the downlink transmissions include a priority associated with the one or more downlink transmissions, a latency constraint associated with the one or more downlink transmissions, an MCS associated with the downlink transmissions, a transmission power associated with the downlink transmissions, or a combination thereof.

Some examples of the method, apparatuses, and non-transitory computer-readable medium described herein may further include operations, features, means, or instructions for transmitting, to the UE, an indication of the one or more thresholds.

Some examples of the method, apparatuses, and non-transitory computer-readable medium described herein may further include operations, features, means, or instructions for obtaining, from the second network entity and via the one or more time and frequency resources, a message associated with the CLI channel measurement.

In some examples of the method, apparatuses, and non-transitory computer-readable medium described herein, outputting the one or more downlink transmissions may include operations, features, means, or instructions for outputting the one or more downlink transmissions via one or more second time and frequency resources excluded from the downlink preemption pattern.

In some examples of the method, apparatuses, and non-transitory computer-readable medium described herein, the recurring downlink preemption pattern applies to a set of types of downlink transmissions including at least SSB messages.

In some examples of the method, apparatuses, and non-transitory computer-readable medium described herein, the set of types of downlink transmissions includes PDSCH transmissions, PDCCH transmissions, CSI-RSs, and SPS transmissions.

In some examples of the method, apparatuses, and non-transitory computer-readable medium described herein, the downlink preemption pattern indicates one or more subbands for which the downlink transmissions to the UE may be preempted, one or more REs for which the downlink transmission to the UE may be preempted, or a frequency band including the one or more subbands or the one or more REs for which the downlink transmissions to the UE may be preempted, the one or more time and frequency resources included in the one or more subbands, the one or more REs, or the frequency band.

Some examples of the method, apparatuses, and non-transitory computer-readable medium described herein may further include operations, features, means, or instructions for outputting the control message includes outputting the control message via L2 signaling. L3 signaling, a MAC-CE, RRC signaling, or DCI.

A method for wireless communication at a first network entity associated with a first cell is described. The method may include outputting, to a second network entity associated with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a third cell and obtaining, from the third network entity via the one or more time and frequency resources, a message associated with the CLI channel measurement based on the indication of the downlink preemption pattern.

An apparatus for wireless communication at a first network entity associated with a first cell is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the first network entity to output, to a second network entity associate with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a third cell and obtain, from the third network entity via the one or more time and frequency resources, a message associated with the CLI channel measurement based on the indication of the downlink preemption pattern.

Another apparatus for wireless communication at a first network entity associated with a first cell is described. The apparatus may include means for outputting, to a second network entity associated with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a third cell and means for obtaining, from the third network entity via the one or more time and frequency resources, a message associated with the CLI channel measurement based on the indication of the downlink preemption pattern.

A non-transitory computer-readable medium storing code for wireless communication at a first network entity associated with a first cell is described. The code may include instructions executable by at least one processor (e.g., directly, indirectly, after pre-processing, without pre-processing) to output, to a second network entity associate with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a third cell and obtain, from the third network entity via the one or more time and frequency resources, a message associated with the CLI channel measurement based on the indication of the downlink preemption pattern.

In some examples of the method, apparatuses, and non-transitory computer-readable medium described herein, outputting the control message may include operations, features, means, or instructions for outputting the control message via a central unit (CU) associated with the first network entity to a CU associated with the second network entity.

In some examples of the method, apparatuses, and non-transitory computer-readable medium described herein, outputting the control message may include operations, features, means, or instructions for outputting the control message via a CU associated with the first network entity to a distributed unit (DU) associated with the second network entity.

In some examples of the method, apparatuses, and non-transitory computer-readable medium described herein, outputting the control message may include operations, features, means, or instructions for outputting the control message to the second network entity via over the air (OTA) signaling.

In some examples of the method, apparatuses, and non-transitory computer-readable medium described herein, the recurring downlink preemption pattern applies to a set of types of downlink transmissions including at least SSB messages.

In some examples of the method, apparatuses, and non-transitory computer-readable medium described herein, the set of types of downlink transmissions includes PDSCH transmissions, PDCCH transmissions, CSI-RSs, and SPS transmissions.

In some examples of the method, apparatuses, and non-transitory computer-readable medium described herein, the downlink preemption pattern indicates one or more subbands for which the downlink transmissions to a UE may be preempted, one or more REs for which the downlink transmissions to the UE may be preempted, or a frequency band including the one or more subbands or the one or more REs for which the downlink transmissions to the UE may be preempted, the one or more time and frequency resources included in the one or more subbands, the one or more REs, or the frequency band.

In some examples of the method, apparatuses, and non-transitory computer-readable medium described herein, the recurring downlink preemption pattern may be periodic or semi-persistent.

A method for wireless communication at a second network entity is described. The method may include obtaining, from a first network entity, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a second cell and outputting one or more downlink transmissions to a UE based on the indication of the downlink preemption pattern.

An apparatus for wireless communication at a second network entity is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the second network entity to obtain, from a first network entity, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a second cell and output one or more downlink transmissions to a UE based on the indication of the downlink preemption pattern.

Another apparatus for wireless communication at a second network entity is described. The apparatus may include means for obtaining, from a first network entity, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a second cell and means for outputting one or more downlink transmissions to a UE based on the indication of the downlink preemption pattern.

A non-transitory computer-readable medium storing code for wireless communication at a second network entity is described. The code may include instructions executable by at least one processor (e.g., directly, indirectly, after pre-processing, without pre-processing) to obtain, from a first network entity, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a second cell and output one or more downlink transmissions to a UE based on the indication of the downlink preemption pattern.

In some examples of the method, apparatuses, and non-transitory computer-readable medium described herein, obtaining the control message may include operations, features, means, or instructions for obtaining the control message via a CU associated with the first network entity at a CU associated with the second network entity.

In some examples of the method, apparatuses, and non-transitory computer-readable medium described herein, obtaining the control message may include operations, features, means, or instructions for obtaining the control message via a CU associated with the first network entity at a DU associated with the second network entity.

In some examples of the method, apparatuses, and non-transitory computer-readable medium described herein, obtaining the control message may include operations, features, means, or instructions for obtaining the control message from the first network entity via OTA signaling.

In some examples of the method, apparatuses, and non-transitory computer-readable medium described herein, the recurring downlink preemption pattern applies to a set of types of downlink transmissions including at least SSB messages.

In some examples of the method, apparatuses, and non-transitory computer-readable medium described herein, the set of types of downlink transmissions includes PDSCH transmissions, PDCCH transmissions, CSI-RSs, and SPS transmissions.

In some examples of the method, apparatuses, and non-transitory computer-readable medium described herein, the downlink preemption pattern indicates one or more subbands for which the downlink transmissions to the UE may be preempted, one or more REs for which the downlink transmissions to the UE may be preempted, or a frequency band including the one or more subbands or the one or more REs for which the downlink transmissions to the UE may be preempted, the one or more time and frequency resources included in the one or more subbands, the one or more REs, or the frequency band.

In some examples of the method, apparatuses, and non-transitory computer-readable medium described herein, outputting the one or more downlink transmissions may include operations, features, means, or instructions for outputting, contrary to the downlink preemption pattern, the one or more downlink transmissions via the one or more time and frequency resources based on one or more parameters associated with the downlink transmissions satisfying one or more thresholds.

In some examples of the method, apparatuses, and non-transitory computer-readable medium described herein, the one or more parameters associated with the downlink transmissions include a priority associated with the one or more downlink transmissions, a latency constraint associated with the one or more downlink transmissions, an MCS associated with the downlink transmissions, a transmission power associated with the downlink transmissions, or a combination thereof.

Some examples of the method, apparatuses, and non-transitory computer-readable medium described herein may further include operations, features, means, or instructions for receiving, from the first network entity, an indication of the one or more thresholds.

In some examples of the method, apparatuses, and non-transitory computer-readable medium described herein, the recurring downlink preemption pattern may be periodic or semi-persistent.

In some examples of the method, apparatuses, and non-transitory computer-readable medium described herein, outputting the one or more downlink transmissions may include operations, features, means, or instructions for outputting the one or more downlink transmissions via one or more second time and frequency resources excluded from the downlink preemption pattern.

Some examples of the method, apparatuses, and non-transitory computer-readable medium described herein may further include operations, features, means, or instructions for canceling transmitting downlink signaling via the one or more time and frequency resources in accordance with the downlink preemption pattern.

Some examples of the method, apparatuses, and non-transitory computer-readable medium described herein may further include operations, features, means, or instructions for transmitting, to the UE, an indication of the downlink preemption pattern.

### BRIEF DESCRIPTION OF THE DRAWINGS

FIGS. 1 and 2 show examples of wireless communications systems that support downlink preemption pattern indication signaling in accordance with one or more aspects of the present disclosure.

FIG. 3 shows an example of a resource diagram that supports downlink preemption pattern indication signaling in accordance with one or more aspects of the present disclosure.

FIGS. 4 and 5 show examples of process flows that support downlink preemption pattern indication signaling in accordance with one or more aspects of the present disclosure.

FIGS. 6 and 7 show block diagrams of devices that support downlink preemption pattern indication signaling in accordance with one or more aspects of the present disclosure.

FIG. 8 shows a block diagram of a communications manager that supports downlink preemption pattern indication signaling in accordance with one or more aspects of the present disclosure.

FIG. 9 shows a diagram of a system including a device that supports downlink preemption pattern indication signaling in accordance with one or more aspects of the present disclosure.

FIGS. 10 and 11 show block diagrams of devices that support downlink preemption pattern indication signaling in accordance with one or more aspects of the present disclosure.

FIG. 12 shows a block diagram of a communications manager that supports downlink preemption pattern indication signaling in accordance with one or more aspects of the present disclosure.

FIG. 13 shows a diagram of a system including a device that supports downlink preemption pattern indication signaling in accordance with one or more aspects of the present disclosure.

FIGS. 14 through 25 show flowcharts illustrating methods that support downlink preemption pattern indication signaling in accordance with one or more aspects of the present disclosure.

### DETAILED DESCRIPTION

In some wireless communications systems, a network entity (e.g., a victim network entity) may perform one or more channel measurements (e.g., cross link interference (CLI) channel measurements) between the network entity and one or more neighbor network entities (e.g., an aggressor network entity). For example, by measuring the CLI channel between the victim network entity and the aggressor network entity, the victim network entity may perform various actions (e.g., perform receive beam nulling, indicate non-preferred aggressor network entity beams, among other actions) to reduce (e.g., mitigate, compensate for) CLI. However, concurrent downlink transmissions from the victim network entity (e.g., and one or more neighbor and non-aggressor network entities) to user equipments (UEs) may interfere with and therefore reduce an accuracy of the channel measurements. Accordingly, in some examples, the victim network entity may preempt transmission of (e.g., refrain from transmitting) downlink transmissions for a duration (e.g., while performing CLI channel measurements). In such examples, however, the UEs communicating with the victim network entity may continue to monitor for downlink transmissions, and thus may unnecessarily increase power consumption. Additionally, the neighbor network entities (e.g., non-aggressor network entities) may continue to transmit downlink signaling during the period of the channel measurements and may therefore cause interference reduce channel measurement accuracy and quality.

Accordingly, techniques, systems, and devices described herein may support the victim network entity sharing a downlink preemption (e.g., muting) pattern with UEs served by the victim network entity and with neighboring network entities (e.g., which in turn may share the downlink preemption pattern with UEs served by the neighboring network entities). For example, the victim network entity may transmit, to a UE, control signaling indicating a recurring (e.g., periodic or semi-persistent) downlink preemption pattern defining one or more resources (e.g., time and frequency resources) during which downlink transmissions by the victim network entity are preempted (e.g., during which the UE may not receive downlink signaling from the victim network entity). For example, the UE may receive a message (e.g., via layer 1 (L1) signaling, layer 2 (L2) signaling, via layer 3 (L3) signaling) configuring the UE with one or more downlink preemption patterns. In some cases, the UE may additionally receive a second message indicating a downlink preemption pattern from the one or more downlink preemption patterns.

The UE may refrain from monitoring for and receiving downlink transmissions in accordance with the indicated downlink preemption pattern and may therefore reduce power consumption and processing associated with monitoring the one or more resources. Additionally, the victim network entity may refrain from transmitting downlink transmissions via the one or more resources, which may therefore reduce interference at the victim network entity to increase an accuracy and quality of CLI channel measurements performed on one or more CLI messages communicated via the one or more resources. In some examples, the UE and the victim network entity may be configured with one or more conditions (power thresholds, transmission priorities, among other conditions) for discarding the indicated downlink preemption pattern and communicating downlink transmissions via the one or more resources.

Additionally, or alternatively, the victim network entity may transmit an indication of the downlink preemption pattern to the one or more neighbor network entities (e.g., non-aggressor network entities). For example, the network entity may indicate the downlink preemption pattern via backhaul signaling (e.g., F1 application protocol (F1AP) signaling, Xn signaling) or over the air (OTA) signaling. The neighbor network entities may refrain from transmitting downlink transmissions in accordance with the indicated downlink preemption pattern. Accordingly, the interference caused by downlink signaling from the neighbor network entities may be reduced (e.g., eliminated) and an accuracy of the channel measurements may be increased. In some examples, the neighbor network entities may be configured with one or more conditions (power thresholds, transmission priorities, among other conditions) for discarding the indicated downlink preemption or muting pattern and transmitting one or more downlink transmissions to UEs served by the neighboring network entities.

Aspects of the disclosure are initially described in the context of wireless communications systems. Aspects of the disclosure are further illustrated by and described with reference to resource diagrams and process flow diagrams. Aspects of the disclosure are further illustrated by and described with reference to apparatus diagrams, system diagrams, and flowcharts that relate to downlink preemption pattern indication signaling.

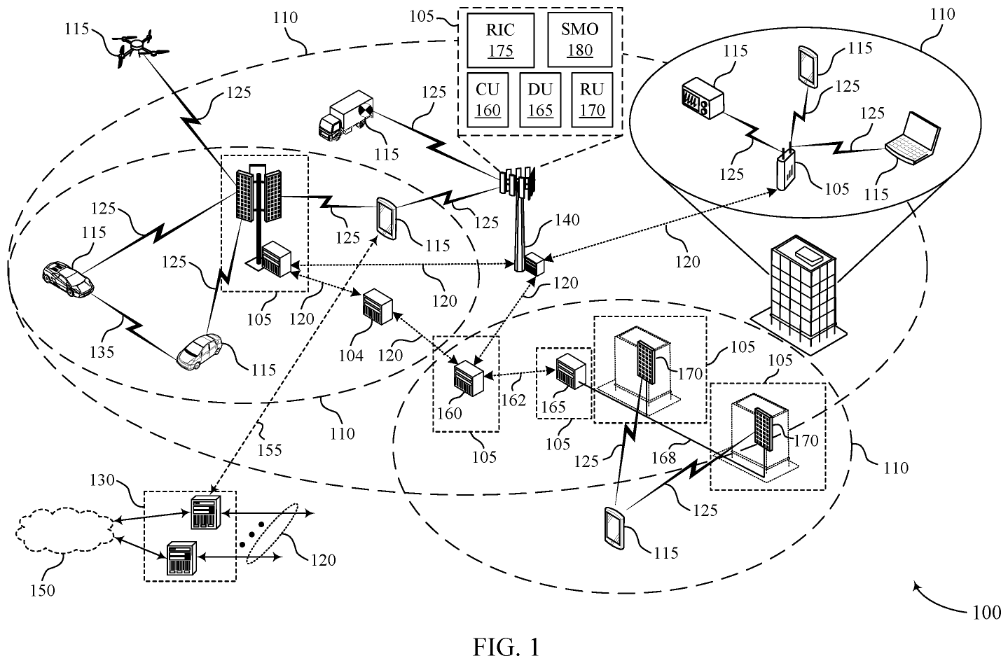

FIG. 1 shows an example of a wireless communications system 100 that supports downlink preemption pattern indication signaling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., L3, L2) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as L1 (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support downlink preemption pattern indication signaling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element (RE) may refer to resources of one symbol period (e.g., a duration of one modulation symbol) and one subcarrier, in which case the symbol period and subcarrier spacing may be inversely related. The quantity of bits carried by each may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Network entities 105 may support inter-network entity CLI measurements to determine CLI channels between network entities 105. For example, downlink transmissions by a first network entity 105 may interfere with communications at a second network entity 105, and such interference may be referred to as CLI. Here, the first network entity 105 that causes the interference may be referred to as an “aggressor” network entity 105, and the second network entity 105 that experiences the interference caused by the first network entity may be referred to as a “victim” network entity 105. The first network entity 105 may transmit a message, which may be referred to as a CLI message, that the second network entity 105 may measure to determine a CLI channel (e.g., a CLI channel matrix) between the second network entity 105 and the first network entity 105. The second network entity 105 may use the CLI channel to determine (e.g., estimate) CLI between the network entities 105 and perform various actions accordingly, such as performing reception nulling (e.g., beamform nulling, digital interference cancelation), estimating dominant directions or beams in the CLI channel, indicating non-preferred aggressor network entity beams, determining a combiner that considers inter-network entity CLI, among other actions. As such, accurately measuring the CLI channel between victim and aggressor network entities 105 may improve communications at the network entities (e.g., increase reliability, inform scheduling and communication parameter decisions to support higher data rates, increased spectral efficiency and capacity, among other benefits).

Techniques described herein may allow for a victim network entity 105 to share a downlink preemption (e.g., muting) pattern with UEs 115 and neighboring network entities 105. For example, the victim network entity 105 may transmit, to a UE 115, control signaling indicating a recurring (e.g., periodic or semi-persistent) downlink preemption pattern defining one or more resources (e.g., time and frequency resources) for which downlink transmission to the UE 115 are preempted. For example, the UE 115 may receive a message configuring the UE 115 with one or more downlink preemption patterns. In some cases, the UE 115 may additionally receive a message indicating (e.g., activating) a downlink preemption pattern from the one or more downlink preemption patterns. The UE 115 may refrain from monitoring for downlink transmissions in accordance with the indicated downlink preemption pattern and may therefore reduce power consumption associated with monitoring the one or more resources. Additionally, the victim network entity 105 may refrain from transmitting downlink transmissions via the one or more resources to reduce (e.g., eliminate) self-interference at the victim network entity 105 that may reduce an accuracy of CLI measurements performed using the one or more resources. In some examples, the UE 115 and the victim network entity 105 may be configured with one or more conditions (power thresholds, transmission priorities, among other conditions) for discarding the indicated downlink preemption pattern and communicating downlink transmissions via the one or more resources.

Additionally, or alternatively, the victim network entity 105 may transmit an indication of the downlink preemption pattern to the one or more neighbor network entities 105 (e.g., non-aggressor network entities). For example, the victim network entity 105 may indicate the downlink preemption pattern via backhaul signaling (e.g., F1AP signaling. Xn signaling) or OTA signaling. The neighbor network entities 105 may refrain from transmitting downlink transmissions in accordance with the indicated downlink preemption pattern. Accordingly, interference caused by downlink signaling from the neighbor network entities 105 may be reduced (e.g., eliminated) and an accuracy of the CLI channel measurements at the victim network entity 105 may be increased. In some examples, the neighbor network entities 105 may be configured with one or more conditions (power thresholds, transmission priorities, among other conditions) for discarding the indicated downlink preemption pattern and transmitting one or more downlink transmissions to UEs within cells served by the neighbor network entities 105.

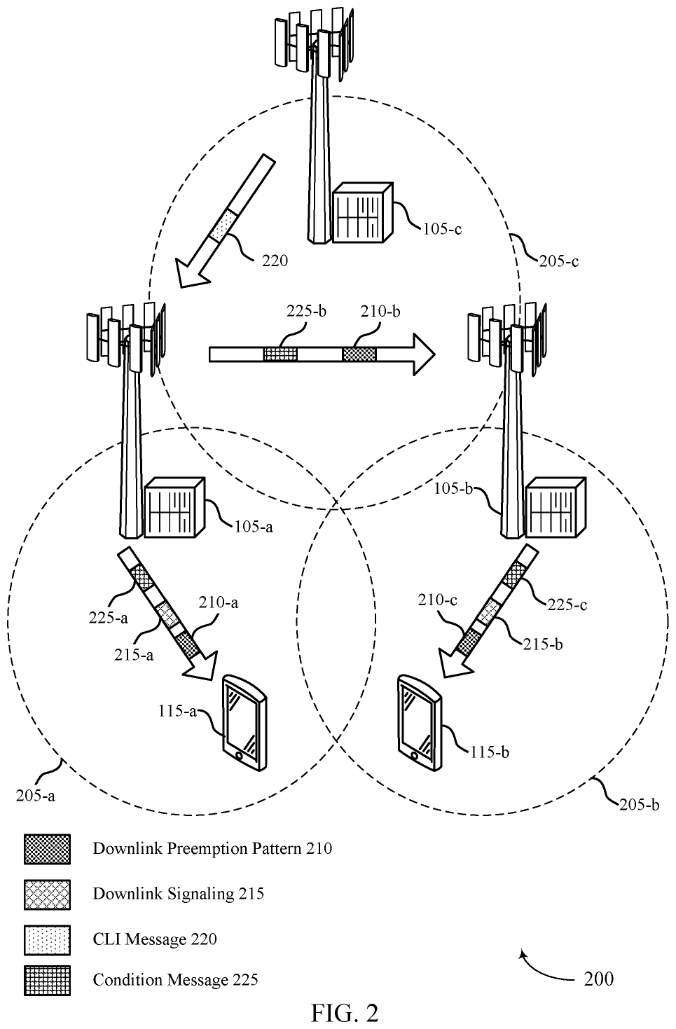

FIG. 2 shows an example of a wireless communications system 200 that supports downlink preemption pattern indication signaling in accordance with one or more aspects of the present disclosure. The wireless communications system 200 may implement aspects of or may be implemented by aspects of the wireless communications system 100. For example, the wireless communications system 200 may include a UE 115 (e.g., a UE 115-a) and a network entity 105 (e.g., a network entity 105-a), which may be examples of corresponding devices as described with reference to FIG. 1.

In some wireless communications systems, a network entity 105-a supporting (e.g., serving) a cell 205-a (e.g., a victim network entity 105-a) may perform one or more channel measurements (e.g., CLI channel measurements) between the network entity 105-a and a network entity 105-c (e.g., an aggressor network entity 105-c) supporting a cell 205-c. CLI may include interference between UEs 115 (e.g., inter- or intra-subband, inter- or intra-cell, inter-UE 115 CLI), interference between network entities 105 (e.g., inter- or intra-subband, inter-network entity 105 CLI), or some combination thereof. The network entity 105-c may be referred to as an aggressor network entity 105 in the context of causing CLI at the network entity 105-a, and the network entity 105-a may be referred to as a “victim” network entity 105-a in context of experiencing CLI caused by the network entity 105-c. By measuring the CLI channel between the victim network entity 105-a and the aggressor network entity 105-c, the victim network entity 105-a may perform various actions (e.g., perform receive beam nulling, perform digital interference cancelation, indicate non-preferred aggressor network entity beams, among other actions) to reduce or mitigate CLI and improve communications at the victim network entity 105-a.

The network entities 105 may support communicating according to various duplex modes, such as a half-duplex mode and a full duplex mode. In some examples, the victim network entity 105-a may operate in a full duplex mode (e.g., a subband full duplex (SBFD) mode) in which the victim network entity 105-a may transmit and receive signals in a same duration (e.g., a same slot) in different frequency subbands. Such techniques may reduce latency and enhance capability of the system by allowing increased UE coverage, dynamic resource adaption according to traffic (e.g., uplink or downlink traffic), and other benefits. In the example of multi-input, multi output (MIMO) full duplex, the victim network entity 105-a may transmit downlink signaling 215 to a UE 115-a operating in the cell 205-a of the victim network entity 105-a in a same duration (e.g., a same time duration) as the victim network entity 105-a receives a message (e.g., a CLI message 220) from the aggressor network entity 105-c. That is, the victim network entity 105-a may concurrently transmit downlink signaling 215 to the UE 115-a and receive signaling from another network entity 105, such as the CLI message 220 from the aggressor network entity 105-c.

However, if the victim network entity 105-a concurrently transmits downlink signaling 215 and receives the message, the downlink signaling 215 may cause self-interference (e.g., clutter) or CLI and may therefore result in inaccurate CLI channel measurements. For example, the aggressor network entity 105-c may transmit the CLI message 220 to the victim network entity 105-a, which the victim network entity 105-a may measure to determine the CLI channel between the victim network entity 105-a and the aggressor network entity 105-c, but interference caused by the transmission of the concurrent downlink signaling 215 by the victim network entity 105-a may reduce an accuracy of the measurements of the CLI message 220 thereby degrading a quality of the CLI channel measurement.

Accordingly, in some examples, the victim network entity 105-a may preempt transmission of (e.g., refrain from transmitting) downlink signaling 215-a for a duration (e.g., while the victim network entity 105-a is performing CLI channel measurements, during reception of the CLI message 220). In such examples, however, a UE 115-a served by the cell 205-a of the victim network entity 105-a may continue to monitor for downlink signaling 215-a, and thus may unnecessarily increase power consumption at the UE 115-a. In some examples, the UE 115-a may receive a downlink control information (DCI) message (e.g., a DownlinkPreemption message in DCI format 2_1) which may indicate for the UE 115-a to perform downlink puncturing, but may not indicate for the UE 115-a to refrain from monitoring for all downlink transmissions (e.g., including synchronization signal blocks (SSBs)). Further, such DCI may refer to a single set of dynamically indicated resources to puncture, but CLI measurements between the victim network entity 105-a and the aggressor network entity 105-c may be recurring (e.g., periodic, semi-persistently scheduled).

Additionally, in some cases, one or more neighbor network entities 105 (e.g., non-aggressor network entities 105, network entities unassociated with the CLI channel measurement between the network entities 105-a and 105-c) may transmit downlink signaling 215 concurrent with the CLI channel measurement. For example, a neighbor network entity 105-b associated with (e.g., supporting, serving) a cell 205-b may transmit downlink signaling 215-b to a UE 115-b served by the cell 205-b of the neighbor network entity 105-b during the channel measurements (e.g., communication of the CLI message 220). The one or more neighbor network entities 105 may transmit the downlink signaling 215-b in a same (e.g., or overlapping, nearby) frequency band (e.g., subband) via which the victim network entity 105-a receives the CLI message and/or at a high transmission power such that the downlink signaling 215-b may cause interference and reduce an accuracy of the CLI channel measurements at the victim network entity 105-a.

Accordingly, techniques described herein may support the victim network entity 105-a indicating a downlink preemption pattern 210-a to the UE 115-a. For example, the victim network entity 105-a may transmit, to the UE 115-a, a control message indicating a recurring (e.g., periodic or semi-persistent) downlink preemption pattern 210-a defining one or more resources (e.g., time and/or frequency resources) for which downlink signaling 215-a to the UE 115-a is preempted. For example, the UE 115-a may receive a control message configuring the UE 115-a with one or more downlink preemption patterns 210. For instance, the victim network entity 105-a may transmit L1 signaling (e.g., DCI) that indicates the downlink preemption pattern 210-a to the UE 115-a. Alternatively, the victim network entity 105-a may transmit L2 signaling (e.g., a medium access control-control element (MAC-CE)) or L3 signaling (e.g., RRC signaling) that indicates the downlink preemption pattern 210-a. Alternatively, the victim network entity 105-a may transmit L3 signaling that indicates a set of downlink preemption patterns 210 to the UE 115-a. Here, the UE 115-a may additionally receive a second control message (e.g., via L2 signaling, such as a MAC-CE, or via L1 signaling, such as DCI) indicating the downlink preemption pattern 210-a from the set of downlink preemption patterns 210.

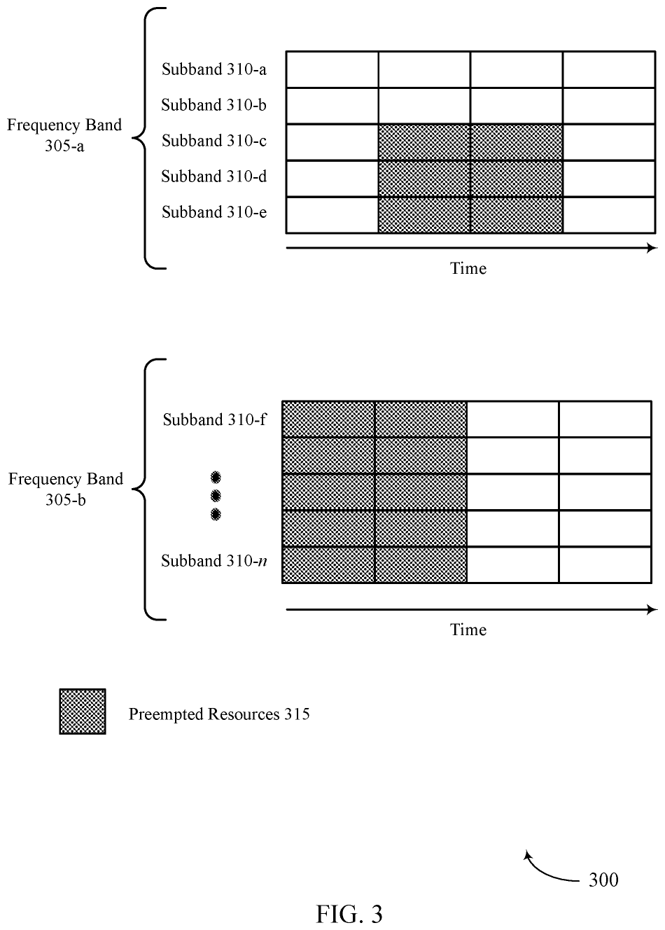

The UE 115-a may refrain from monitoring for (e.g., preempt reception of) downlink signaling 215-a in accordance with the indicated downlink preemption pattern 210-a. For example, the UE 115-a may refrain from monitoring for one or more types of downlink signaling 215-a (e.g., all types of downlink signaling 215-a), such as including SSBs, physical uplink shared channel (PUSCH) transmissions, physical downlink control channel (PDCCH) transmissions, channel state information reference signals (CSI-RSs), and semi-persistent scheduling (SPS) transmissions, or a combination thereof, among other types of downlink signaling 215. That is, the UE 115-a may cancel monitoring for and reception of downlink signaling 215-a via the one or more resources indicated by the downlink preemption pattern 210-a. Additionally, or alternatively, the UE 115-a may refrain from activating (e.g., deactivate) a receiver chain, which may result in reduced power consumption. Similarly, the victim network entity 105-a may refrain from transmitting (e.g., preempt transmission of, cancel transmission of) the downlink signaling 215-a in accordance with the indicated downlink preemption pattern 210-a (e.g., including the deactivation of one or more transmission chains). The downlink preemption pattern 210-a may apply to a wideband frequency band, one or more frequency subbands, one or more REs, or a combination thereof, as described in further detail with reference to FIG. 3.

In some examples, the downlink preemption pattern 210-a may be conditional and the UE 115-a and victim network entity 105-a may be configured with one or more conditions for discarding the indicated downlink preemption pattern 210-a and communicating the downlink signaling 215-a via the one or more resources. That is, the downlink signaling 215-a may be communicated contrary to (e.g., despite) the downlink preemption pattern 210-a if the one or more conditions are satisfied (e.g., if one or more parameters associated with the downlink signaling 215-a satisfy one or more thresholds).

For example, the UE 115-a may monitor for and the victim network entity 105-a may transmit the downlink signaling 215-a if the downlink signaling 215-a has a priority that satisfies (e.g., meets or exceeds) a threshold priority (e.g., a L1 priority). In some examples, the UE 115-a may monitor for and the victim network entity 105-a may transmit the downlink signaling 215-a if the downlink signaling 215-a is latency-sensitive (e.g., if the downlink transmission is an ultra-reliable low latency communications (URLLC) or extended reality (XR) transmission). That is, the downlink signaling 215-a may be communicated if a latency constraint associated with the downlink signaling 215-a satisfies a threshold latency. In some examples, the UE 115-a may monitor for and the victim network entity 105-a may transmit the downlink signaling 215-a if the downlink signaling 215-a has a modulation and coding scheme (MCS) or a transmission power which that satisfy (e.g., is less than, is less than or equal to) respective thresholds. For example, as relatively lower powered transmissions may cause a relatively low level of interference, such that CLI channel measurement accuracy may be maintained, and thus the downlink signaling 215-a may be communicated contrary to the downlink preemption pattern 210-a with little to no effect on the CLI channel measurement.

In some examples, the UE 115-a and the victim network entity 105-a may follow one or more conditions for discarding the indicated downlink preemption pattern 210-a according to a defined rule (e.g., a rule defined by a wireless communications standard, such as 3rd Generation Partnership Project (3GPP) standard). That is, the one or more conditions may be defined by the rule, and the UE 115-a and the victim network entity 105-a may communicate or preempt communication of the downlink signaling in accordance with the one or more conditions without communication of the one or more conditions between the UE 115-a and the victim network entity 105-a. In some examples, the UE 115-a may follow one or more conditions for discarding the indicated downlink preemption pattern 210-a as indicated by the victim network entity 105-a. For example, the victim network entity 105-a may transmit a condition message 225-a that indicates the one or more conditions (e.g., the one or more thresholds) for discarding the downlink preemption pattern 210-a. In some examples, the one or more conditions may be determined at a CU or a DU associated with the victim network entity 105-a or via an operations, administration and maintenance (OAM) indication.

Additionally, or alternatively, the victim network entity 105-a may transmit an indication of a downlink preemption pattern 210-b to one or more neighbor network entities 105 (e.g., non-aggressor network entities 105), such as the neighbor network entity 105-b. For example, the victim network entity 105-a may indicate the downlink preemption pattern 210-b via backhaul signaling (e.g., F1AP signaling, such as from a CU of the victim network entity 105-a to a DU of the neighbor network entity 105-b, or via Xn signaling, such as from the CU of the victim network entity 105-a to a CU of the neighbor network entity 105-b) or via OTA signaling. As with the downlink signaling 215-a, the neighbor network entity 105-b may preempt transmission of (e.g., refrain from transmitting) downlink signaling 215-b (including SSBs, PUSCH transmissions, PDCCH transmissions, CSI-RSs, SPS transmissions, or a combination thereof, among other types of downlink signaling) to the UE 115-b in accordance with the indicated downlink preemption pattern 210-b. The downlink preemption pattern 210-b may apply to a wideband frequency band, one or more frequency subbands, one or more REs, or a combination thereof, as described in further detail with reference to FIG. 3.

In some examples, the neighbor network entity 105-b may transmit an indication of a downlink preemption pattern 210-c to the UE 115-b such that the UE 115-b may refrain from monitoring for the downlink signaling 215-b as indicated by the downlink preemption pattern 210-c. For example, the neighbor network entity 105-b may transmit (e.g., forward) the downlink preemption pattern 210-b received from the victim network entity 105-a to the UE 115-b (e.g., as the downlink preemption pattern 210-c) such that the UE 115-b may preempt reception of the downlink signaling 215-b in accordance with the downlink preemption pattern 210-c.

In some examples, the downlink preemption pattern 210-b may be conditional and the neighbor network entity 105-b and the UE 115-b may be configured with one or more conditions for discarding the indicated downlink preemption pattern 210-b and transmitting the downlink signaling 215-b. That is, the downlink signaling 215-b may be communicated contrary to (e.g., despite) the downlink preemption pattern 210-b if the one or more conditions are satisfied (e.g., if one or more parameters associated with the downlink signaling 215-b satisfy one or more thresholds).

For example, the neighbor network entity 105-b may transmit and the UE 115-b may receive the downlink signaling 215-b if the downlink signaling 215-b has a priority that satisfies a threshold priority (e.g., L1 priority). In some examples, the neighbor network entity 105-b may transmit and the UE 115-b may receive the downlink signaling 215-b if the downlink signaling 215-b is latency-sensitive (e.g., if the downlink transmission is an URLLC or XR transmission). In some examples, the neighbor network entity 105-b may transmit and the UE 115-b may receive the downlink signaling 215-b if the downlink signaling 215-b has an MCS or a transmission power that satisfy respective thresholds, as relatively lower powered transmissions may cause relatively little (e.g., no) interference that may adversely impact the CLI channel measurement at the victim network entity 105-a.

In some examples, the neighbor network entity 105-b and the UE 115-b may follow the one or more conditions for discarding the indicated downlink preemption pattern 210-b according to a defined rule. In some examples, the neighbor network entity 105-b may follow one or more conditions for discarding the indicated downlink preemption pattern 210-b as indicated by the victim network entity 105-a. For example, the victim network entity 105-a may transmit a condition message 225-b that indicates the one or more conditions (e.g., the one or more thresholds) for discarding the downlink preemption pattern 210-b. In turn, the neighbor network entity 105-b may transmit a condition message 225-c to the UE 115-b that indicates the one or more conditions to the UE 115-c.

Based on operating according to the downlink preemption patterns 210, the victim network entity 105-a may receive one or more CLI messages 220 (e.g., a CLI reference signal (RS)) from the aggressor network entity 105-c with reduced (e.g., limited) interference (e.g., self-interference or CLI) from downlink signaling 215 relative to if the downlink signaling 215 were transmitted. For example, the victim network entity 105-a may receive one or more CLI messages 220 via the one or more resources indicated by the downlink preemption patterns 210. The victim network entity 105-a may, for example, use (e.g., measure) the one or more CLI messages 220 to determine a per-tone channel (e.g., to perform beamforming nulling or digital interference cancelation), to estimate a dominant direction or beam in the CLI channel to the aggressor network entity 105-c, determine a band combiner (e.g., an antenna duplexer) with performance metrics which exceed a threshold to reduce CLI, or a combination thereof, such as with increased accuracy due to the reduced interference experienced at the victim network entity 105-a.

FIG. 3 shows an example of a resource diagram 300 that supports downlink preemption pattern indication signaling in accordance with one or more aspects of the present disclosure. The resource diagram 300 may implement aspects of or may be implemented by aspects of the wireless communications system 100 or the wireless communications system 200. For example, the resource diagram 300 may be implemented by a UE 115 and a network entity 105, which may be examples of the corresponding devices as described with reference to FIG. 1 and FIG. 2.

As described with reference to FIG. 2, a victim network entity 105 may transmit an indication of a downlink preemption pattern to a UE 115 served by a cell of the victim network entity 105 and to a neighbor network entity 105 (e.g., which the neighbor network entity 105 may forward to one or more UEs 115 served by the neighbor network entity 105). The downlink preemption pattern may indicate preempted resources 315 which the UE 115, the victim network entity 105, and the neighbor network entity 105 may not use for communication of downlink transmissions. The preempted resources 315 may be, for example, time and/or frequency resources.

In some cases, the preempted resources 315 may include resources (e.g., REs) spanning one or more subbands 310. In the example of a frequency band 305-a, which may be an example of a wideband frequency band, the preempted resources 315 may include resources in a subband 310-c, a subband 310-d, and a subband 310-c. The preempted resources 315 may not include resources in a subband 310-a and a subband 310-b. Thus, in the example of the frequency band 305-a, the UE 115, the victim network entity 105-a, and the neighbor network entity 105 may communicate via resources (e.g., REs) in the subband 310-a and the subband 310-b in a same duration (e.g., a time duration) in which the resources 315 are preempted. In other words, in the example of the frequency band 305-a, the downlink preemption pattern may be subband-specific or RE-specific.

In the example of a frequency band 305-b, which may be an example of a wideband frequency band, the preempted resources 315 may include all frequency resources in the frequency band 305-b (e.g., all REs in a subband 310-f through a subband 310-n). That is, in the example of the frequency band 305-b, the downlink preemption pattern may be wideband specific. In such examples, the UE 115, the victim network entity, and the neighbor network entity 105 may not communicate downlink signaling in the frequency band 305-b for the duration (e.g., time duration, quantity of slots or symbols) that the resources 315 are preempted. The subband 310-f through the subband 310-n may together be referred to as wideband resources.

As described with reference to FIG. 2, the victim network entity 105 may receive one or more messages for CLI channel measurements from an aggressor network entity 105 via the preempted resources 315. In some cases, in the example of the frequency band 305-a, the victim network entity 105 and the aggressor network entity 105 may operate in an SBFD mode and the preempted resources 315 may fall within subbands 310 allocated for uplink transmissions for the victim network entity 105 (e.g., subbands 310 allocated for downlink transmissions for the aggressor network entity 105). In some cases, in the example of the frequency band 305-b, the victim network entity 105 and the aggressor network entity 105 may operate in a dynamic TDD mode.

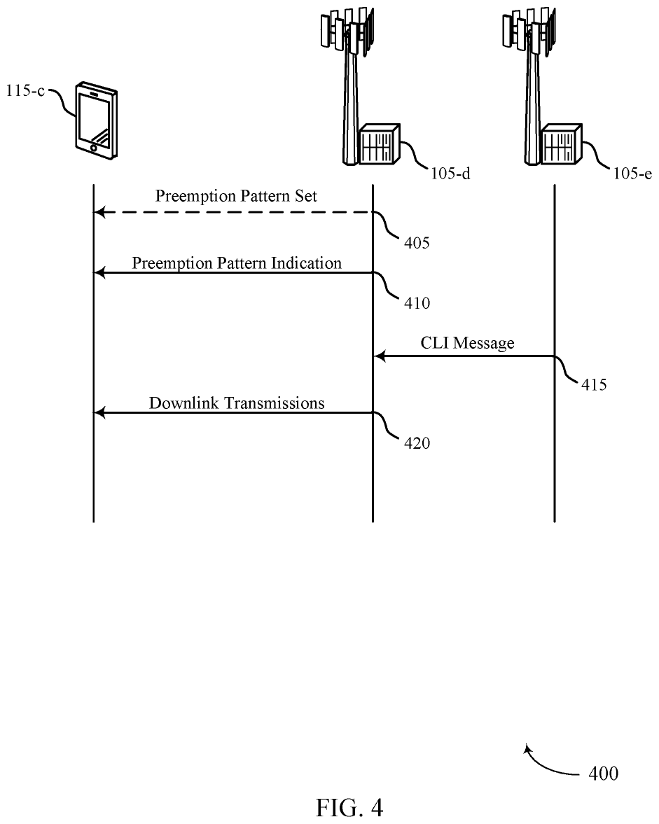

FIG. 4 shows an example of a process flow 400 that supports downlink preemption pattern indication signaling in accordance with one or more aspects of the present disclosure. The process flow 400 may implement aspects of or may be implemented by aspects of the wireless communications system 100, the wireless communications system 200, or the resource diagram 300. For example, the process flow 400 may include a UE 115 (e.g., a UE 115-c) and one or more network entities 105 (e.g., a network entity 105-d and a network entity 105-e), which may be examples of the corresponding devices as described with reference to FIG. 1 and FIG. 2. The network entity 105-d and the network entity 105-e may operate in (e.g., support) a first cell and a second cell, respectively.

In the following description of the process flow 400, the operations between the network entity 105-d, the network entity 105-e, and the UE 115-c may be transmitted in a different order than the example order shown. Some operations may also be omitted from the process flow 400, and other operations may be added to the process flow 400. Further, although some operations or signaling may be shown to occur at different times for discussion purposes, these operations may actually occur at the same time.

In some examples, at 405, the network entity 105-d (e.g., a victim network entity 105) may transmit a set of recurring downlink preemption patterns to the UE 115-c. For example, the network entity 105-d may configure the UE 115-c with multiple recurring downlink preemption patterns (e.g., via RRC signaling). The network entity 105-d may configure the multiple recurring downlink preemption patterns semi-statically (e.g., periodically or semi-persistently).

At 410, the network entity 105-d may indicate a recurring downlink preemption pattern to the UE 115-c. For example, the network entity 105-d may indicate the recurring downlink preemption pattern, such as from the set of recurring downlink preemption patterns or as a standalone indication (e.g., an indication of the downlink preemption pattern without indication of the set of downlink preemption patterns). The network entity 105-d may indicate the recurring downlink preemption pattern in a control message transmitted via L2 signaling (e.g., a MAC-CE), L3 signaling (e.g., RRC signaling), or DCI.

The recurring downlink preemption pattern may define one or more resources (e.g., time and/or frequency resources) for which downlink transmissions may be preempted. For example, the one or more resources may be reserved for CLI channel measurements between the network entity 105-d and the network entity 105-e (e.g., an aggressor network entity 105). The one or more resources may include one or more frequency subbands or REs which may span part or all of a frequency band (e.g., a wideband frequency band). The recurring downlink preemption pattern may apply to a set of types of downlink transmissions (e.g., all types of downlink transmissions) via the one or more resources (including one or more of SSB messages, PUSCH transmissions, PDCCH transmissions, CSI-RSs, and SPS transmissions, among other types of downlink transmissions).

At 415, the network entity 105-d may receive one or more messages associated with the CLI channel measurements from the network entity 105-e. For example, the network entity 105-d may receive the one or more messages (e.g., CLI messages 220) via the one or more resources defined by the recurring downlink preemption pattern. The network entity 105-d may measure the one or more messages to determine a CLI channel between the network entity 105-d and the network entity 105-e. If the downlink transmissions via the one or more resources are preempted by the UE 115-c and network entity 105-d in accordance with the downlink preemption pattern, interference experienced at the network entity 105-d associated with the downlink transmissions (e.g., self-interference) may be reduced (e.g., eliminated), which may increase a quality and accuracy of the CLI channel measurement.

At 420, the UE 115-c may receive one or more downlink transmissions from the network entity 105-d. In some examples, the UE 115-c may receive the one or more downlink transmissions via one or more second resources different than the one or more resources defined by the recurring downlink preemption pattern. In such examples, the UE 115-c may refrain from monitoring (e.g., cancel monitoring or receiving transmissions via) the one or more resources defined by the recurring downlink preemption pattern, and the network entity 105-d may refrain from (e.g., cancel) transmitting via the one or more resources defined by the recurring downlink preemption pattern.

In some examples, the UE 115-c may receive the one or more downlink transmissions from the network entity 105-d via the one or more resources defined by the recurring downlink preemption pattern. For example, the UE 115-c and the network entity 105-d may discard (e.g., ignore) the recurring downlink preemption pattern if one or more parameters associated with the one or more downlink transmissions satisfy one or more thresholds. The one or more parameters may include one or more of a priority, a latency constraint, an MCS level, and a transmission power of the one or more downlink transmissions. In some examples, the UE 115-c may determine the one or more thresholds according to a defined rule. In some examples, the network entity 105-d may transmit an indication of the one or more thresholds to the UE 115-c.

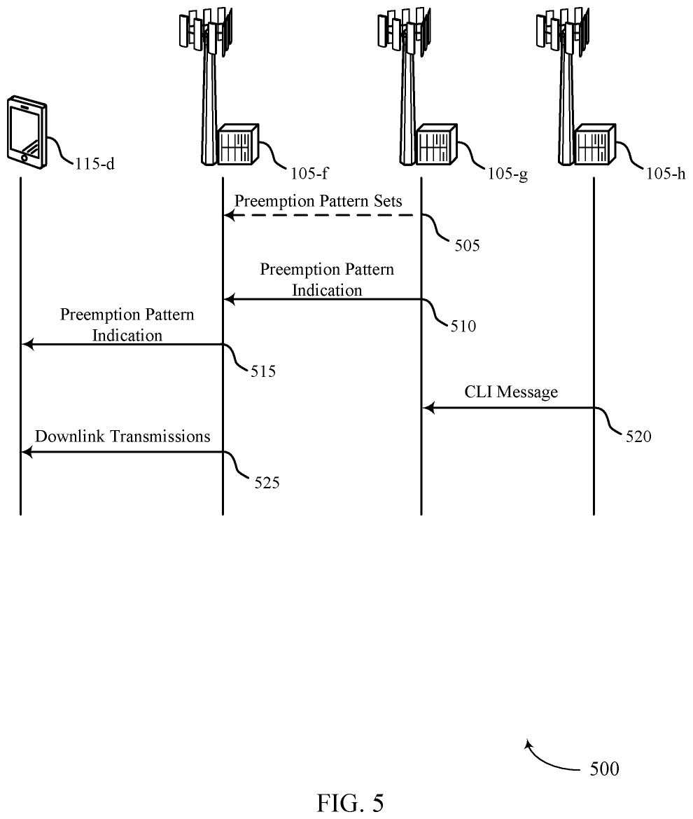

FIG. 5 shows an example of a process flow 500 that supports downlink preemption pattern indication signaling in accordance with one or more aspects of the present disclosure. The process flow 500 may implement aspects of or may be implemented by aspects of the wireless communications system 100, the wireless communications system 200, or the resource diagram 300. For example, the process flow 500 may include a UE 115 (e.g., a UE 115-d) and one or more network entities 105 (e.g., a network entity 105-f, a network entity 105-g, and a network entity 105-h), which may be examples of the corresponding devices as described with reference to FIG. 1. The network entity 105-f, the network entity 105-g, and the network entity 105-h may operate in a first cell, a second cell, and a third cell, respectively.

In the following description of the process flow 500, the operations between the network entity 105-f, the network entity 105-g, the network entity 105-h, and the UE 115-d may be transmitted in a different order than the example order shown. Some operations may also be omitted from the process flow 500, and other operations may be added to the process flow 500. Further, although some operations or signaling may be shown to occur at different times for discussion purposes, these operations may actually occur at the same time.

In some examples, at 505, the network entity 105-g (e.g., a victim network entity 105) may transmit a set of recurring downlink preemption patterns to the network entity 105-f (e.g., a neighbor network entity 105). For example, the network entity 105-g may configure the network entity 105-f with multiple recurring downlink preemption patterns (e.g., via RRC signaling). The network entity 105-g may configure the multiple recurring downlink preemption patterns semi-statically (e.g., periodically or semi-persistently).

At 510, the network entity 105-g may indicate a recurring downlink preemption pattern to the network entity 105-f. For example, the network entity 105-g may indicate the recurring downlink preemption pattern, such as from the set of recurring downlink preemption patterns or as a standalone indication. In some examples, the network entity 105-g may indicate the recurring downlink preemption pattern in a control message output from a CU of the network entity 105-g to a CU (e.g., via F1AP signaling) or a DU (e.g., via Xn signaling) of the network entity 105-f. In some examples, the network entity 105-g may indicate the recurring downlink preemption pattern in a control message via OTA signaling.

The recurring downlink preemption pattern may define one or more resources (e.g., time and/or frequency resources) for downlink transmissions by the network entity 105-f may be preempted. For example, the one or more resources may be reserved for CLI channel measurements between the network entity 105-g and the network entity 105-h (e.g., an aggressor network entity 105). The one or more resources may include one or more frequency subbands or one or more REs which may span part or all of a frequency band (e.g., a wideband frequency band). The recurring downlink preemption pattern may apply to a set of types of downlink transmissions (e.g., all types of downlink transmissions) via the one or more resources (including one or more of SSB messages, PUSCH transmissions, PDCCH transmissions, CSI-RSs, and SPS transmissions, among other types of downlink transmissions).

At 515, the network entity 105-f may transmit an indication of the recurring downlink preemption pattern to the UE 115-d, which may be served by the first cell associated with the network entity 105-f. In some examples, the UE 115-d may refrain from monitoring (e.g., cancel monitoring and receiving signaling via) the one or more resources indicated by the downlink preemption pattern. That is, the UE 115-d may preempt monitoring and reception of downlink transmissions via the one or more resources in accordance with the downlink preemption pattern. In some examples, the UE 115-d may discard the recurring downlink preemption pattern, such as if one or more conditions are satisfied.

At 520, the network entity 105-g may receive one or more messages associated with the CLI channel measurements from the network entity 105-h. For example, the network entity 105-g may receive the one or more messages via the resources defined by the recurring downlink preemption pattern. The network entity 105-g may measure the one or more messages to determine a CLI channel between the network entity 105-g and the network entity 105-h. If the downlink transmissions via the one or more resources are preempted by the network entity 105-f in accordance with the downlink preemption pattern, interference experienced at the network entity 105-g associated with the downlink transmissions (e.g., CLI caused by the network entity 105-f) may be reduced (e.g., eliminated), which may increase a quality and accuracy of the CLI channel measurement.

At 525, the network entity 105-f may transmit one or more downlink transmissions to the UE 115-d. In some examples, the network entity 105-f may transmit the one or more downlink transmissions via one or more second resources different than the one or more resources defined by the recurring downlink preemption pattern. That is, the network entity 105-f may refrain from transmitting (e.g., cancel transmission of, preempt transmission of) the downlink transmissions via the one or more resources defined by the recurring downlink preemption pattern.

In some examples, the network entity 105-f may transmit the one or more downlink transmissions to the UE 115-d via the one or more resources defined by the recurring downlink preemption pattern. For example, the network entity 105-f may discard (e.g., ignore) the recurring downlink preemption pattern if one or more parameters associated with the one or more downlink transmissions satisfy one or more thresholds. The one or more parameters may include one or more of a priority, a latency constraint, an MCS level, and a transmission power of the one or more downlink transmissions. In some examples, the network entity 105-f may determine the one or more thresholds according to a defined rule. In some examples, the network entity 105-g may transmit an indication of the one or more thresholds to the network entity 105-f.

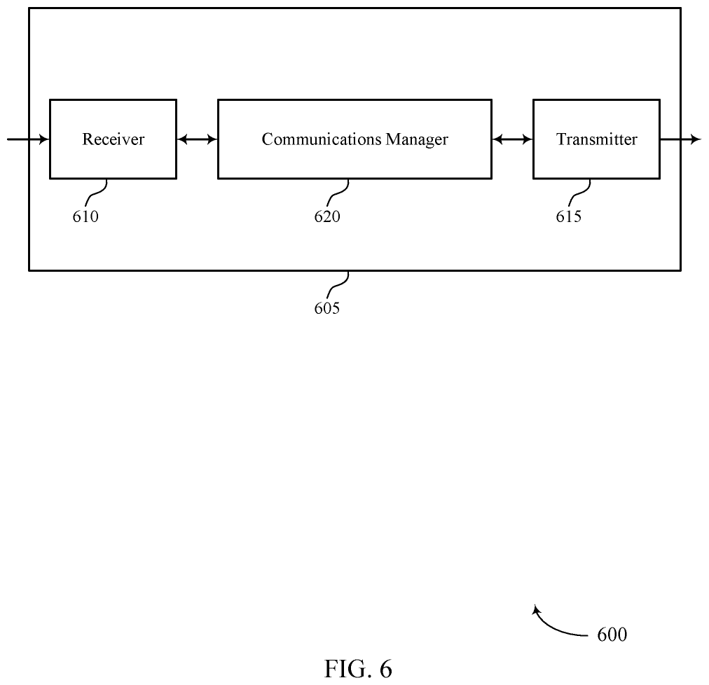

FIG. 6 shows a block diagram 600 of a device 605 that supports downlink preemption pattern indication signaling in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to downlink preemption pattern indication signaling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to downlink preemption pattern indication signaling). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of downlink preemption pattern indication signaling as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 is capable of, configured to, or operable to support a means for receiving a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell. The communications manager 620 is capable of, configured to, or operable to support a means for receiving one or more downlink transmissions based on the indication of the downlink preemption pattern.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for a victim network entity to share a downlink preemption pattern with UEs and neighboring network entities (e.g., which may share the pattern with UEs served by the neighboring network entities), which may result in reduced power consumption and reduced processing, such as resulting from the preemption of communicating downlink signaling in accordance with the downlink preemption pattern.

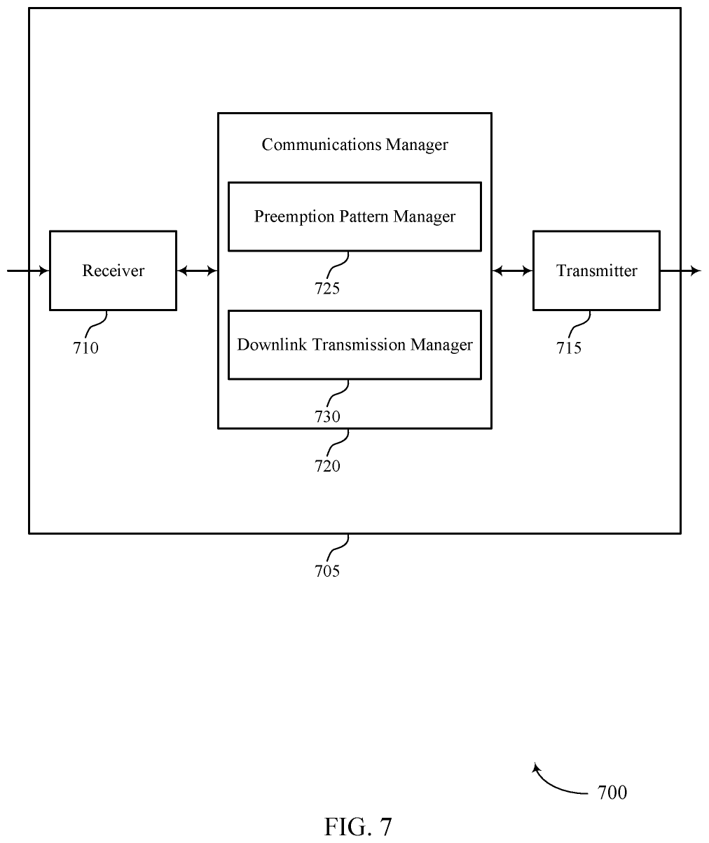

FIG. 7 shows a block diagram 700 of a device 705 that supports downlink preemption pattern indication signaling in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to downlink preemption pattern indication signaling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to downlink preemption pattern indication signaling). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of downlink preemption pattern indication signaling as described herein. For example, the communications manager 720 may include a preemption pattern manager 725 a downlink transmission manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The preemption pattern manager 725 is capable of, configured to, or operable to support a means for receiving a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell. The downlink transmission manager 730 is capable of, configured to, or operable to support a means for receiving one or more downlink transmissions based on the indication of the downlink preemption pattern.

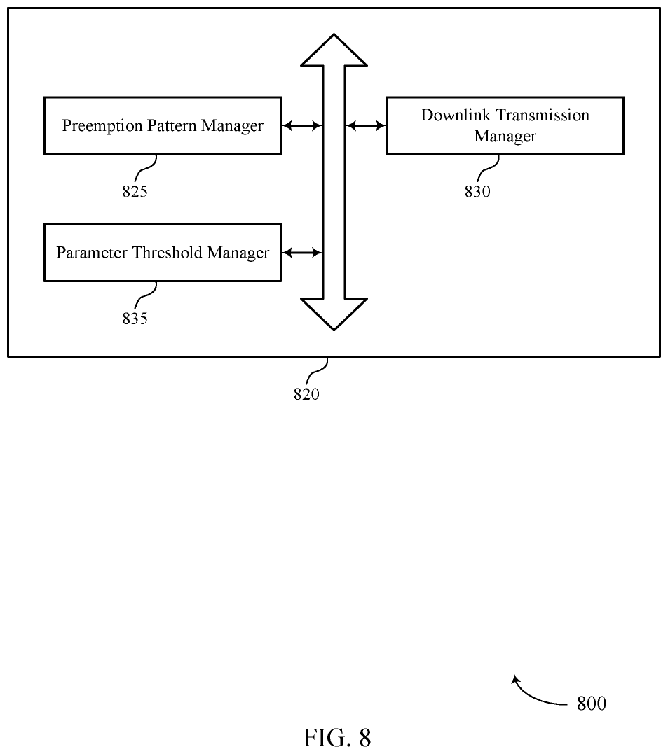

FIG. 8 shows a block diagram 800 of a communications manager 820 that supports downlink preemption pattern indication signaling in accordance with one or more aspects of the present disclosure. The communications manager 820 may be an example of aspects of a communications manager 620, a communications manager 720, or both, as described herein. The communications manager 820, or various components thereof, may be an example of means for performing various aspects of downlink preemption pattern indication signaling as described herein. For example, the communications manager 820 may include a preemption pattern manager 825, a downlink transmission manager 830, a parameter threshold manager 835, or any combination thereof. Each of these components may communicate, directly or indirectly, with one another (e.g., via one or more buses).

The communications manager 820 may support wireless communication at a UE in accordance with examples as disclosed herein. The preemption pattern manager 825 is capable of, configured to, or operable to support a means for receiving a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell. The downlink transmission manager 830 is capable of, configured to, or operable to support a means for receiving one or more downlink transmissions based on the indication of the downlink preemption pattern.

In some examples, the preemption pattern manager 825 is capable of, configured to, or operable to support a means for receiving a second control message indicating a set of recurring downlink preemption patterns, where the recurring downlink preemption pattern is indicated from the set of recurring downlink preemption patterns.

In some examples, the downlink transmission manager 830 is capable of, configured to, or operable to support a means for canceling monitoring and receiving of downlink transmissions via the one or more time and frequency resources in accordance with the downlink preemption pattern.

In some examples, to support receiving the one or more downlink transmissions, the downlink transmission manager 830 is capable of, configured to, or operable to support a means for receiving, contrary to the downlink preemption pattern, the one or more downlink transmissions via the one or more time and frequency resources based on one or more parameters associated with the downlink transmissions satisfying one or more thresholds.

In some examples, the one or more parameters associated with the downlink transmissions include a priority associated with the one or more downlink transmissions, a latency constraint associated with the one or more downlink transmissions, an MCS associated with the downlink transmissions, a transmission power associated with the downlink transmissions, or a combination thereof.

In some examples, the parameter threshold manager 835 is capable of, configured to, or operable to support a means for receiving an indication of the one or more thresholds.

In some examples, to support receiving the one or more downlink transmissions, the downlink transmission manager 830 is capable of, configured to, or operable to support a means for receiving the one or more downlink transmissions via one or more second time and frequency resources excluded from the downlink preemption pattern.

In some examples, the recurring downlink preemption pattern applies to a set of types of downlink transmissions including at least SSB messages.

In some examples, the set of types of downlink transmissions includes PDSCH transmissions, PDCCH transmissions, CSI-RSs, and SPS transmissions.

In some examples, the downlink preemption pattern indicates one or more subbands for which the downlink transmissions to the UE are preempted, one or more REs for which the downlink transmissions to the UE are preempted, or a frequency band including the one or more subbands or the one or more REs for which the downlink transmissions to the UE are preempted, the one or more time and frequency resources included in the one or more subbands, the one or more REs, or the frequency band.

In some examples, receiving the control message includes receiving the control message via L2 signaling, L3 signaling, a MAC-CE, RRC signaling, or DCI.

In some examples, the recurring downlink preemption pattern is periodic or semi-persistent.

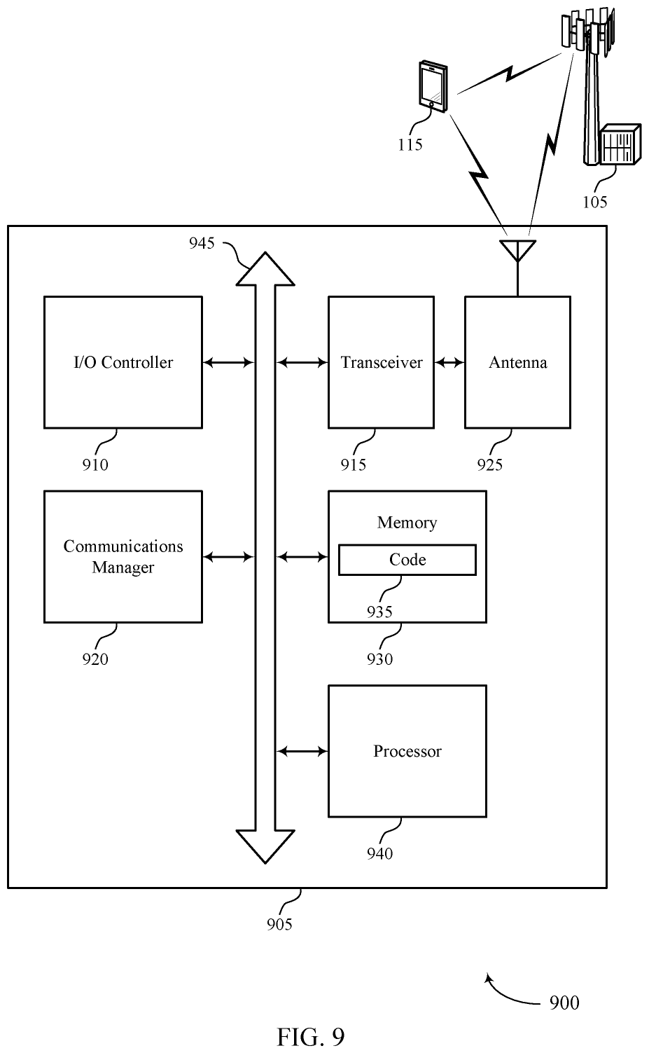

FIG. 9 shows a diagram of a system 900 including a device 905 that supports downlink preemption pattern indication signaling in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting downlink preemption pattern indication signaling). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 is capable of, configured to, or operable to support a means for receiving a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell. The communications manager 920 is capable of, configured to, or operable to support a means for receiving one or more downlink transmissions based on the indication of the downlink preemption pattern.

By including or configuring the communications manager 920 in accordance with examples as described herein, the device 905 may support techniques for a victim network entity to share a downlink preemption pattern with UEs and neighboring network entities, which may result in improved communication reliability, reduced power consumption, longer battery life, more efficient utilization of resources, increased spectral efficiency, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of downlink preemption pattern indication signaling as described herein, or the processor 940 and the memory 930 may be otherwise configured to perform or support such operations.

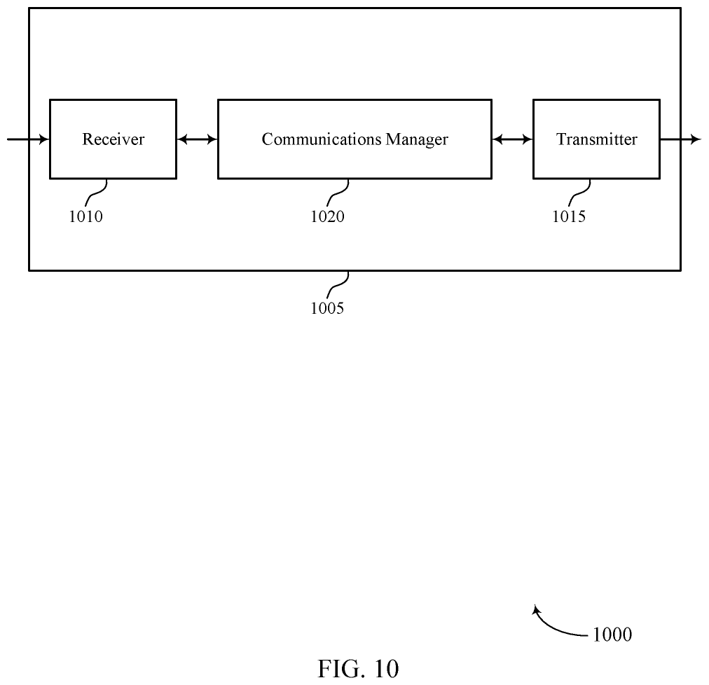

FIG. 10 shows a block diagram 1000 of a device 1005 that supports downlink preemption pattern indication signaling in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of downlink preemption pattern indication signaling as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first network entity (e.g., a victim network entity) associated with a first cell in accordance with examples as disclosed herein. For example, the communications manager 1020 is capable of, configured to, or operable to support a means for outputting a control message including an indication of a recurring downlink preemption pattern defining one or more time and frequency resources for which downlink transmissions to a UE are preempted, the one or more time and frequency resources associated with CLI channel measurement between the first network entity and a second network entity (e.g., an aggressor network entity) associated with a second cell. The communications manager 1020 is capable of, configured to, or operable to support a means for outputting one or more downlink transmissions to the UE based on the indication of the downlink preemption pattern.

Additionally, or alternatively, the communications manager 1020 may support wireless communication at a first network (e.g., a victim network entity) entity associated with a first cell in accordance with examples as disclosed herein. For example, the communications manager 1020 is capable of, configured to, or operable to support a means for outputting, to a second network entity (e.g., a neighbor network entity) associating with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity (e.g., an aggressor network entity) associated with a third cell. The communications manager 1020 is capable of, configured to, or operable to support a means for obtaining, from the third network entity via the one or more time and frequency resources, a message associated with the CLI channel measurement based on the indication of the downlink preemption pattern.

Additionally, or alternatively, the communications manager 1020 may support wireless communication at a second network entity (e.g., a neighbor network entity) in accordance with examples as disclosed herein. For example, the communications manager 1020 is capable of, configured to, or operable to support a means for obtaining, from a first network entity (e.g., a victim network entity), a control message including an indication of a recurring downlink preemption pattern defining one or more time and frequency resources for which downlink transmissions by the second network entity are preempted, the one or more time and frequency resources associated with CLI channel measurement between the first network entity and a third network entity (e.g., an aggressor network entity) associated with a second cell. The communications manager 1020 is capable of, configured to, or operable to support a means for outputting one or more downlink transmissions to a UE based on the indication of the downlink preemption pattern.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for a victim network entity to share a downlink preemption pattern with UEs and neighboring network entities (e.g., which may share the pattern with UEs served by the neighboring network entities), which may result reduced power consumption and reduced processing, such as resulting from the preemption of communicating downlink signaling in accordance with the downlink preemption pattern.

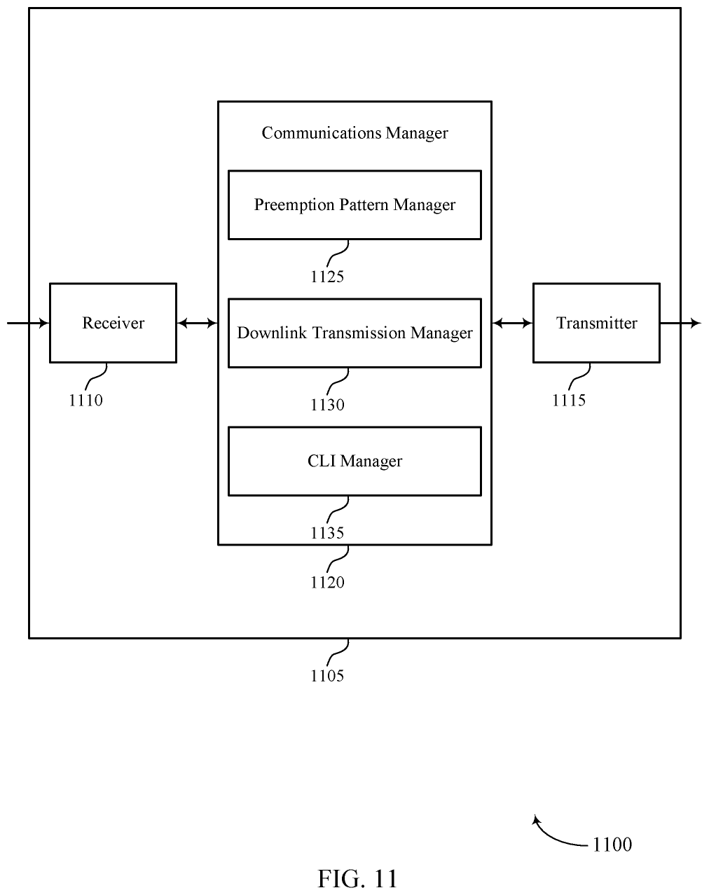

FIG. 11 shows a block diagram 1100 of a device 1105 that supports downlink preemption pattern indication signaling in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of downlink preemption pattern indication signaling as described herein. For example, the communications manager 1120 may include a preemption pattern manager 1125, a downlink transmission manager 1130, a CLI manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first network entity (e.g., a victim network entity) associated with a first cell in accordance with examples as disclosed herein. The preemption pattern manager 1125 is capable of, configured to, or operable to support a means for outputting a control message including an indication of a recurring downlink preemption pattern defining one or more time and frequency resources for which downlink transmissions to a UE are preempted, the one or more time and frequency resources associated with CLI channel measurement between the first network entity and a second network entity (e.g., an aggressor network entity) associated with a second cell. The downlink transmission manager 1130 is capable of, configured to, or operable to support a means for outputting one or more downlink transmissions to the UE based on the indication of the downlink preemption pattern.

Additionally, or alternatively, the communications manager 1120 may support wireless communication at a first network entity (e.g., a victim network entity) associated with a first cell in accordance with examples as disclosed herein. The preemption pattern manager 1125 is capable of, configured to, or operable to support a means for outputting, to a second network entity (e.g., a neighbor network entity) associated with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity (e.g., an aggressor network entity) associated with a third cell. The CLI manager 1135 is capable of, configured to, or operable to support a means for obtaining, from the third network entity via the one or more time and frequency resources, a message associated with the CLI channel measurement based on the indication of the downlink preemption pattern.

Additionally, or alternatively, the communications manager 1120 may support wireless communication at a second network entity (e.g., a neighbor network entity) in accordance with examples as disclosed herein. The preemption pattern manager 1125 is capable of, configured to, or operable to support a means for obtaining, from a first network entity (e.g., a victim network entity), a control message including an indication of a recurring downlink preemption pattern defining one or more time and frequency resources for which downlink transmissions by the second network entity are preempted, the one or more time and frequency resources associated with CLI channel measurement between the first network entity and a third network entity (e.g., an aggressor network entity) associated with a second cell. The downlink transmission manager 1130 is capable of, configured to, or operable to support a means for outputting one or more downlink transmissions to a UE based on the indication of the downlink preemption pattern.

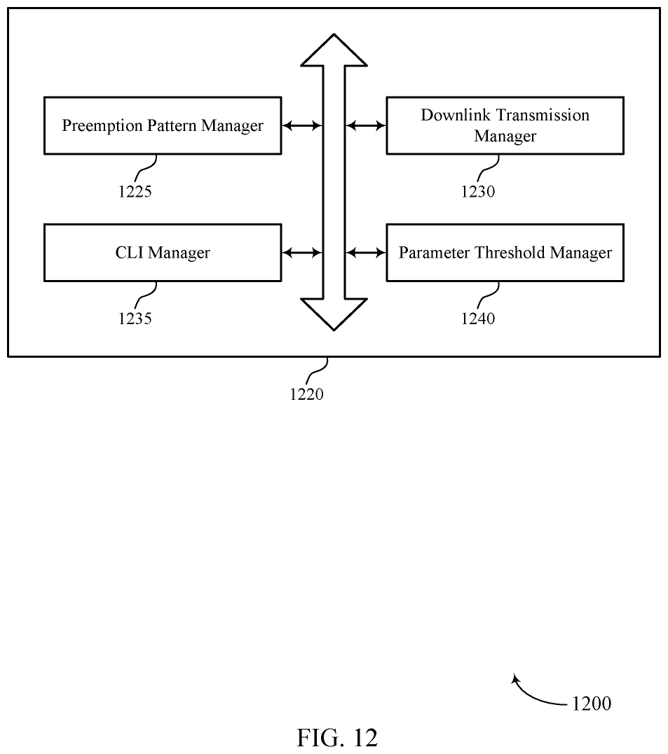

FIG. 12 shows a block diagram 1200 of a communications manager 1220 that supports downlink preemption pattern indication signaling in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of downlink preemption pattern indication signaling as described herein. For example, the communications manager 1220 may include a preemption pattern manager 1225, a downlink transmission manager 1230, a CLI manager 1235, a parameter threshold manager 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a first network entity (e.g., a victim network entity) associated with a first cell in accordance with examples as disclosed herein. The preemption pattern manager 1225 is capable of, configured to, or operable to support a means for outputting a control message including an indication of a recurring downlink preemption pattern defining one or more time and frequency resources for which downlink transmissions to a UE are preempted, the one or more time and frequency resources associated with CLI channel measurement between the first network entity and a second network entity (e.g., an aggressor network entity) associated with a second cell. The downlink transmission manager 1230 is capable of, configured to, or operable to support a means for outputting one or more downlink transmissions to the UE based on the indication of the downlink preemption pattern.

In some examples, the preemption pattern manager 1225 is capable of, configured to, or operable to support a means for outputting a second control message indicating a set of recurring downlink preemption patterns, where the recurring downlink preemption pattern is indicated from the set of recurring downlink preemption patterns.

In some examples, the downlink transmission manager 1230 is capable of, configured to, or operable to support a means for canceling transmitting downlink signaling via the one or more time and frequency resources in accordance with the downlink preemption pattern.

In some examples, to support outputting the one or more downlink transmissions, the downlink transmission manager 1230 is capable of, configured to, or operable to support a means for outputting, contrary to the downlink preemption pattern, the one or more downlink transmissions via the one or more time and frequency resources based on one or more parameters associated with the downlink transmissions satisfying one or more thresholds.

In some examples, the one or more parameters associated with the downlink transmissions include a priority associated with the one or more downlink transmissions, a latency constraint associated with the one or more downlink transmissions, an MCS associated with the downlink transmissions, a transmission power associated with the downlink transmissions, or a combination thereof.

In some examples, the parameter threshold manager 1240 is capable of, configured to, or operable to support a means for transmitting, to the UE, an indication of the one or more thresholds.

In some examples, the CLI manager 1235 is capable of, configured to, or operable to support a means for obtaining, from the second network entity and via the one or more time and frequency resources, a message associated with the CLI channel measurement.

In some examples, to support outputting the one or more downlink transmissions, the downlink transmission manager 1230 is capable of, configured to, or operable to support a means for outputting the one or more downlink transmissions via one or more second time and frequency resources excluded from the downlink preemption pattern.

In some examples, the recurring downlink preemption pattern applies to a set of types of downlink transmissions including at least SSB messages.

In some examples, the set of types of downlink transmissions includes PDSCH transmissions, PDCCH transmissions, CSI-RSs, and SPS transmissions.

In some examples, the downlink preemption pattern indicates one or more subbands for which the downlink transmissions to the UE are preempted, one or more REs for which the downlink transmissions to the UE are preempted, or a frequency band including the one or more subbands or the one or more REs for which the downlink transmissions to the UE are preempted, the one or more time and frequency resources included in the one or more subbands, the one or more REs, or the frequency band.

In some examples, outputting the control message includes outputting the control message via L2 signaling. L3 signaling, a MAC-CE, RRC signaling, or DCI.

Additionally, or alternatively, the communications manager 1220 may support wireless communication at a first network entity (e.g., a victim network entity) associated with a first cell in accordance with examples as disclosed herein. In some examples, the preemption pattern manager 1225 is capable of, configured to, or operable to support a means for outputting, to a second network entity (e.g., a neighbor network entity) associated with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity (e.g., an aggressor network entity) associated with a third cell. The CLI manager 1235 is capable of, configured to, or operable to support a means for obtaining, from the third network entity via the one or more time and frequency resources, a message associated with the CLI channel measurement based on the indication of the downlink preemption pattern.

In some examples, to support outputting the control message, the preemption pattern manager 1225 is capable of, configured to, or operable to support a means for outputting the control message via a CU associated with the first network entity to a CU associated with the second network entity.

In some examples, to support outputting the control message, the preemption pattern manager 1225 is capable of, configured to, or operable to support a means for outputting the control message via a CU associated with the first network entity to a DU associated with the second network entity.

In some examples, to support outputting the control message, the preemption pattern manager 1225 is capable of, configured to, or operable to support a means for outputting the control message to the second network entity via OTA signaling.

In some examples, the recurring downlink preemption pattern applies to a set of types of downlink transmissions including at least SSB messages.

In some examples, the set of types of downlink transmissions includes PDSCH transmissions, PDCCH transmissions, CSI-RSs, and SPS transmissions.

In some examples, the downlink preemption pattern indicates one or more subbands for which the downlink transmissions to a UE are preempted, one or more REs for which the downlink transmissions to the UE are preempted, or a frequency band including the one or more subbands or the one or more REs for which the downlink transmissions to the UE are preempted, the one or more time and frequency resources included in the one or more subbands, the one or more REs, or the frequency band.

In some examples, the recurring downlink preemption pattern is periodic or semi-persistent.

Additionally, or alternatively, the communications manager 1220 may support wireless communication at a second network entity (e.g., a neighbor network entity) in accordance with examples as disclosed herein. In some examples, the preemption pattern manager 1225 is capable of, configured to, or operable to support a means for obtaining, from a first network entity (e.g., a victim network entity), a control message including an indication of a recurring downlink preemption pattern defining one or more time and frequency resources for which downlink transmissions by the second network entity are preempted, the one or more time and frequency resources associated with CLI channel measurement between the first network entity and a third network entity (e.g., an aggressor network entity) associated with a second cell. In some examples, the downlink transmission manager 1230 is capable of, configured to, or operable to support a means for outputting one or more downlink transmissions to a UE based on the indication of the downlink preemption pattern.

In some examples, to support obtaining the control message, the preemption pattern manager 1225 is capable of, configured to, or operable to support a means for obtaining the control message via a CU associated with the first network entity at a CU associated with the second network entity.

In some examples, to support obtaining the control message, the preemption pattern manager 1225 is capable of, configured to, or operable to support a means for obtaining the control message via a CU associated with the first network entity at a DU associated with the second network entity.

In some examples, to support obtaining the control message, the preemption pattern manager 1225 is capable of, configured to, or operable to support a means for obtaining the control message from the first network entity via OTA signaling.

In some examples, the recurring downlink preemption pattern applies to a set of types of downlink transmissions including at least SSB messages.

In some examples, the set of types of downlink transmissions includes PDSCH transmissions, PDCCH transmissions, CSI-RSs, and SPS transmissions.

In some examples, the downlink preemption pattern indicates one or more subbands for which the downlink transmissions to the UE are preempted, one or more REs for which the downlink transmissions to the UE are preempted, or a frequency band including the one or more subbands or the one or more REs for which the downlink transmissions to the UE are preempted, the one or more time and frequency resources included in the one or more subbands, the one or more REs, or the frequency band.

In some examples, to support outputting the one or more downlink transmissions, the downlink transmission manager 1230 is capable of, configured to, or operable to support a means for outputting, contrary to the downlink preemption pattern, the one or more downlink transmissions via the one or more time and frequency resources based on one or more parameters associated with the downlink transmissions satisfying one or more thresholds.

In some examples, the one or more parameters associated with the downlink transmissions include a priority associated with the one or more downlink transmissions, a latency constraint associated with the one or more downlink transmissions, an MCS associated with the downlink transmissions, a transmission power associated with the downlink transmissions, or a combination thereof.

In some examples, the parameter threshold manager 1240 is capable of, configured to, or operable to support a means for receiving, from the first network entity, an indication of the one or more thresholds.

In some examples, the recurring downlink preemption pattern is periodic or semi-persistent.

In some examples, to support outputting the one or more downlink transmissions, the downlink transmission manager 1230 is capable of, configured to, or operable to support a means for outputting the one or more downlink transmissions via one or more second time and frequency resources excluded from the downlink preemption pattern.

In some examples, the downlink transmission manager 1230 is capable of, configured to, or operable to support a means for canceling transmitting downlink signaling via the one or more time and frequency resources in accordance with the downlink preemption pattern.

In some examples, the preemption pattern manager 1225 is capable of, configured to, or operable to support a means for transmitting, to the UE, an indication of the downlink preemption pattern.

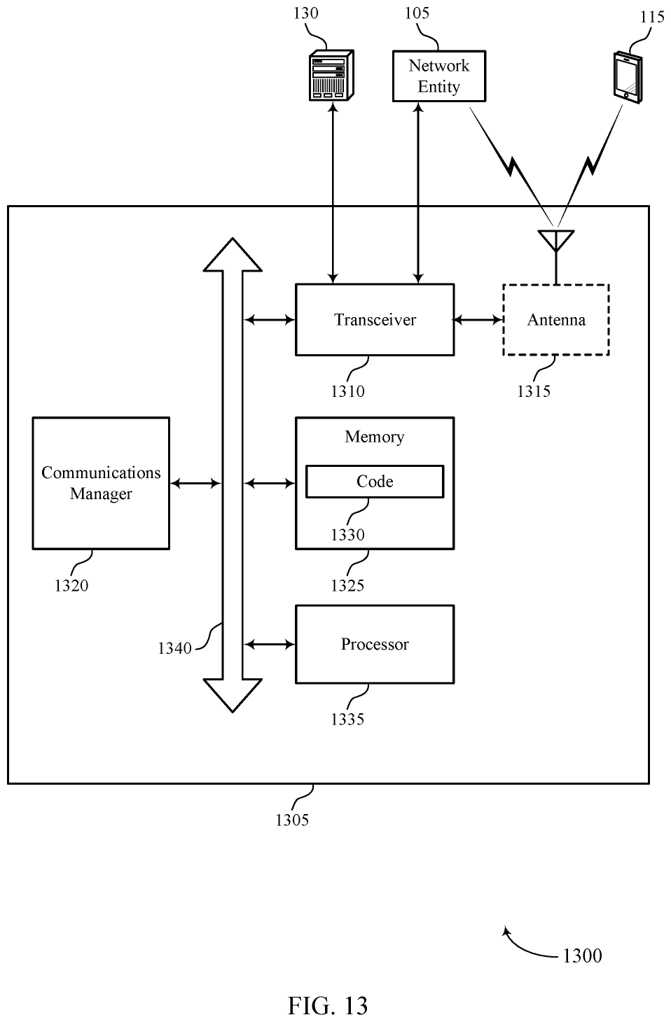

FIG. 13 shows a diagram of a system 1300 including a device 1305 that supports downlink preemption pattern indication signaling in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting downlink preemption pattern indication signaling). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a first network entity (e.g., a victim network entity) associated with a first cell in accordance with examples as disclosed herein. For example, the communications manager 1320 is capable of, configured to, or operable to support a means for outputting a control message including an indication of a recurring downlink preemption pattern defining one or more time and frequency resources for which downlink transmissions to a UE are preempted, the one or more time and frequency resources associated with CLI channel measurement between the first network entity and a second network entity (e.g., an aggressor network entity) associated with a second cell. The communications manager 1320 is capable of, configured to, or operable to support a means for outputting one or more downlink transmissions to the UE based on the indication of the downlink preemption pattern.

Additionally, or alternatively, the communications manager 1320 may support wireless communication at a first network entity (e.g., a victim network entity) associated with a first cell in accordance with examples as disclosed herein. For example, the communications manager 1320 is capable of, configured to, or operable to support a means for outputting, to a second network entity (e.g., a neighbor network entity) associating with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity (e.g., an aggressor network entity) associated with a third cell. The communications manager 1320 is capable of, configured to, or operable to support a means for obtaining, from the third network entity via the one or more time and frequency resources, a message associated with the CLI channel measurement based on the indication of the downlink preemption pattern.

Additionally, or alternatively, the communications manager 1320 may support wireless communication at a second network entity (e.g., a neighbor network entity) in accordance with examples as disclosed herein. For example, the communications manager 1320 is capable of, configured to, or operable to support a means for obtaining, from a first network entity (e.g., a victim network entity), a control message including an indication of a recurring downlink preemption pattern defining one or more time and frequency resources for which downlink transmissions by the second network entity are preempted, the one or more time and frequency resources associated with CLI channel measurement between the first network entity and a third network entity (e.g., an aggressor network entity) associated with a second cell. The communications manager 1320 is capable of, configured to, or operable to support a means for outputting one or more downlink transmissions to a UE based on the indication of the downlink preemption pattern.

By including or configuring the communications manager 1320 in accordance with examples as described herein, the device 1305 may support techniques for a victim network entity to share a downlink preemption pattern with UEs and neighboring network entities, which may result in improved communication reliability, increased CLI channel measurement accuracy, reduced CLI, reduced power consumption, more efficient utilization of resources, increased spectral efficiency, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of downlink preemption pattern indication signaling as described herein, or the processor 1335 and the memory 1325 may be otherwise configured to perform or support such operations.

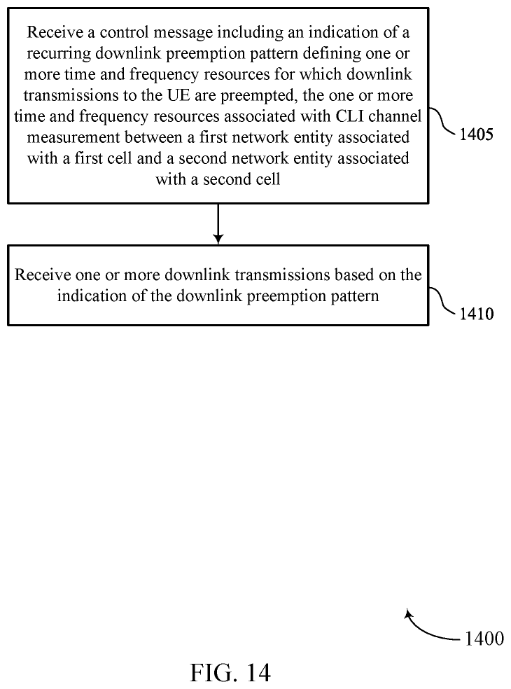

FIG. 14 shows a flowchart illustrating a method 1400 that supports downlink preemption pattern indication signaling in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell. The operations of 1405 may be performed in accordance with examples as disclosed herein. In some examples, aspects of the operations of 1405 may be performed by a preemption pattern manager 825 as described with reference to FIG. 8.

At 1410, the method may include receiving one or more downlink transmissions based on the indication of the downlink preemption pattern. The operations of 1410 may be performed in accordance with examples as disclosed herein. In some examples, aspects of the operations of 1410 may be performed by a downlink transmission manager 830 as described with reference to FIG. 8.

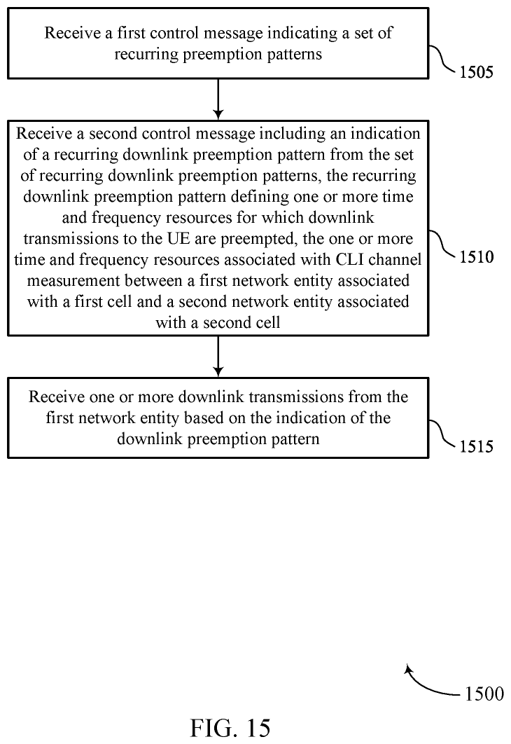

FIG. 15 shows a flowchart illustrating a method 1500 that supports downlink preemption pattern indication signaling in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving a first control message indicating a set of recurring downlink preemption patterns. The operations of 1505 may be performed in accordance with examples as disclosed herein. In some examples, aspects of the operations of 1505 may be performed by a preemption pattern manager 825 as described with reference to FIG. 8.

At 1510, the method may include receiving a second control message including an indication of a recurring downlink preemption pattern from the set of recurring downlink preemption patterns, the recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell. The operations of 1510 may be performed in accordance with examples as disclosed herein. In some examples, aspects of the operations of 1510 may be performed by a preemption pattern manager 825 as described with reference to FIG. 8.

At 1515, the method may include receiving one or more downlink transmissions based on the indication of the downlink preemption pattern. The operations of 1515 may be performed in accordance with examples as disclosed herein. In some examples, aspects of the operations of 1515 may be performed by a downlink transmission manager 830 as described with reference to FIG. 8.

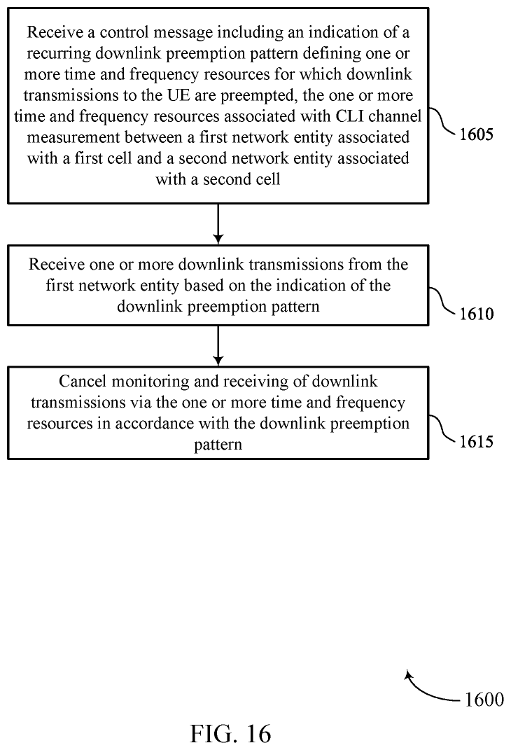

FIG. 16 shows a flowchart illustrating a method 1600 that supports downlink preemption pattern indication signaling in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving a control message including an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell. The operations of 1605 may be performed in accordance with examples as disclosed herein. In some examples, aspects of the operations of 1605 may be performed by a preemption pattern manager 825 as described with reference to FIG. 8.

At 1610, the method may include receiving one or more downlink transmissions based on the indication of the downlink preemption pattern. The operations of 1610 may be performed in accordance with examples as disclosed herein. In some examples, aspects of the operations of 1610 may be performed by a downlink transmission manager 830 as described with reference to FIG. 8.

At 1615, the method may include canceling monitoring and receiving of downlink transmissions via the one or more time and frequency resources in accordance with the downlink preemption pattern. The operations of 1615 may be performed in accordance with examples as disclosed herein. In some examples, aspects of the operations of 1615 may be performed by a downlink transmission manager 830 as described with reference to FIG. 8.

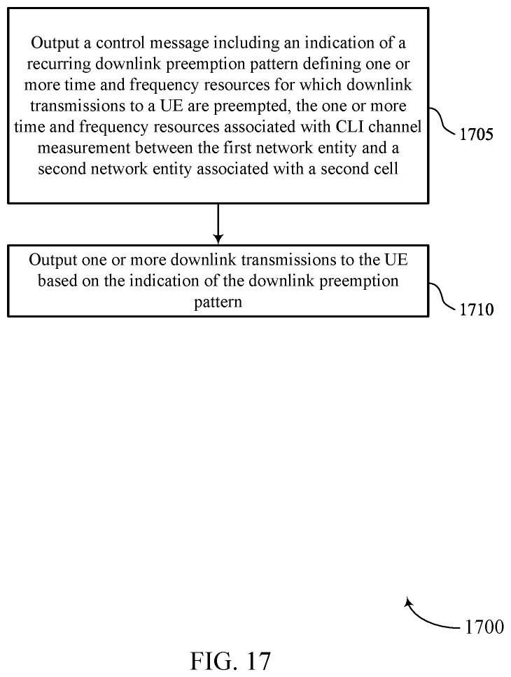

FIG. 17 shows a flowchart illustrating a method 1700 that supports downlink preemption pattern indication signaling in accordance with aspects of the present disclosure. The operations of the method 1700 may be implemented by a first network entity or its components as described herein. For example, the operations of the method 1700 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include outputting a control message including an indication of a recurring downlink preemption pattern defining one or more time and frequency resources for which downlink transmissions to a UE are preempted, the one or more time and frequency resources associated with CLI channel measurement between the first network entity and a second network entity associated with a second cell. The operations of 1705 may be performed in accordance with examples as disclosed herein. In some examples, aspects of the operations of 1705 may be performed by a preemption pattern manager 1225 as described with reference to FIG. 12.

At 1710, the method may include outputting one or more downlink transmissions to the UE based on the indication of the downlink preemption pattern. The operations of 1710 may be performed in accordance with examples as disclosed herein. In some examples, aspects of the operations of 1710 may be performed by a downlink transmission manager 1230 as described with reference to FIG. 12.

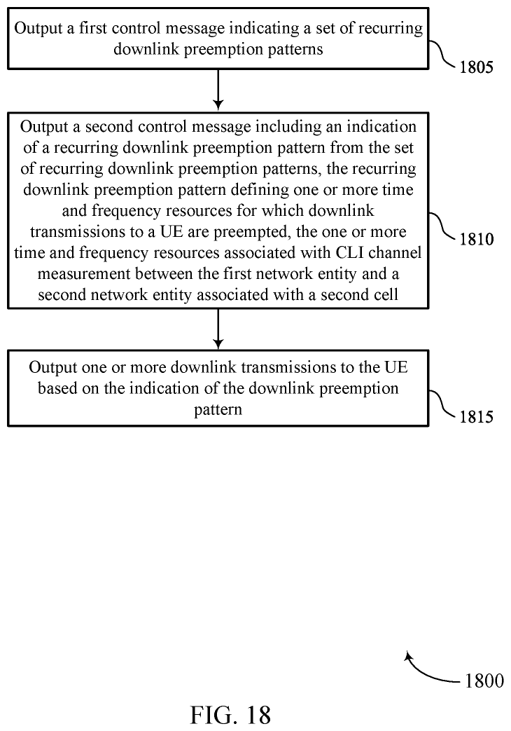

FIG. 18 shows a flowchart illustrating a method 1800 that supports downlink preemption pattern indication signaling in accordance with aspects of the present disclosure. The operations of the method 1800 may be implemented by a first network entity or its components as described herein. For example, the operations of the method 1800 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include outputting a first control message indicating a set of recurring downlink preemption patterns. The operations of 1805 may be performed in accordance with examples as disclosed herein. In some examples, aspects of the operations of 1805 may be performed by a preemption pattern manager 1225 as described with reference to FIG. 12.

At 1810, the method may include outputting a second control message including an indication of a recurring downlink preemption pattern from the set of recurring downlink preemption patterns, the recurring downlink preemption pattern defining one or more time and frequency resources for which downlink transmissions to a UE are preempted, the one or more time and frequency resources associated with CLI channel measurement between the first network entity and a second network entity associated with a second cell. The operations of 1810 may be performed in accordance with examples as disclosed herein. In some examples, aspects of the operations of 1810 may be performed by a preemption pattern manager 1225 as described with reference to FIG. 12.

At 1815, the method may include outputting one or more downlink transmissions to the UE based on the indication of the downlink preemption pattern. The operations of 1815 may be performed in accordance with examples as disclosed herein. In some examples, aspects of the operations of 1815 may be performed by a downlink transmission manager 1230 as described with reference to FIG. 12.

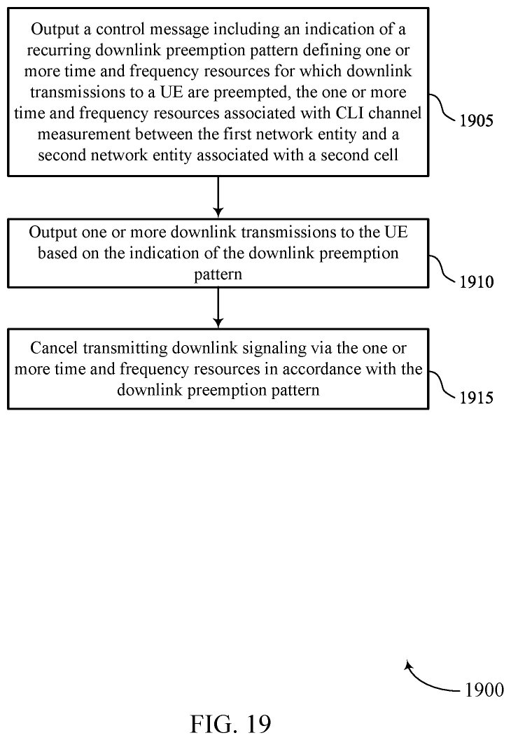

FIG. 19 shows a flowchart illustrating a method 1900 that supports downlink preemption pattern indication signaling in accordance with aspects of the present disclosure. The operations of the method 1900 may be implemented by a first network entity or its components as described herein. For example, the operations of the method 1900 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1905, the method may include outputting a control message including an indication of a recurring downlink preemption pattern defining one or more time and frequency resources for which downlink transmissions to a UE are preempted, the one or more time and frequency resources associated with CLI channel measurement between the first network entity and a second network entity associated with a second cell. The operations of 1905 may be performed in accordance with examples as disclosed herein. In some examples, aspects of the operations of 1905 may be performed by a preemption pattern manager 1225 as described with reference to FIG. 12.

At 1910, the method may include outputting one or more downlink transmissions to the UE based on the indication of the downlink preemption pattern. The operations of 1910 may be performed in accordance with examples as disclosed herein. In some examples, aspects of the operations of 1910 may be performed by a downlink transmission manager 1230 as described with reference to FIG. 12.

At 1915, the method may include canceling transmitting downlink signaling via the one or more time and frequency resources in accordance with the downlink preemption pattern. The operations of 1915 may be performed in accordance with examples as disclosed herein. In some examples, aspects of the operations of 1915 may be performed by a downlink transmission manager 1230 as described with reference to FIG. 12.

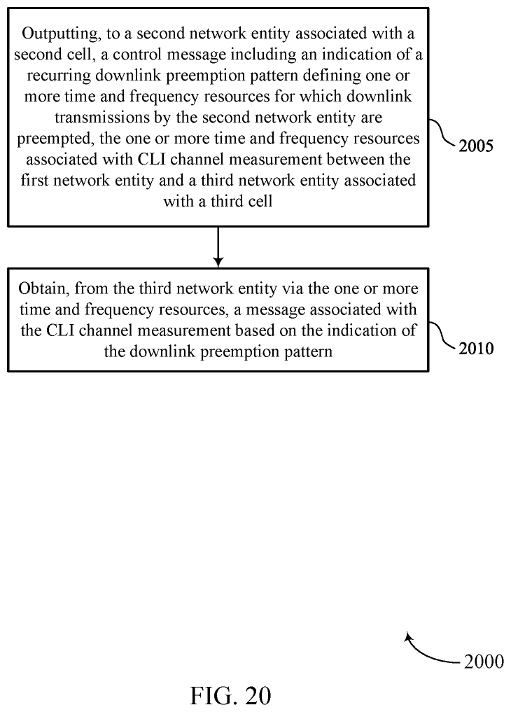

FIG. 20 shows a flowchart illustrating a method 2000 that supports downlink preemption pattern indication signaling in accordance with aspects of the present disclosure. The operations of the method 2000 may be implemented by a first network entity or its components as described herein. For example, the operations of the method 2000 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 2005, the method may include outputting, to a second network entity associated with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a third cell. The operations of 2005 may be performed in accordance with examples as disclosed herein. In some examples, aspects of the operations of 2005 may be performed by a preemption pattern manager 1225 as described with reference to FIG. 12.

At 2010, the method may include obtaining, from the third network entity via the one or more time and frequency resources, a message associated with the CLI channel measurement based on the indication of the downlink preemption pattern. The operations of 2010 may be performed in accordance with examples as disclosed herein. In some examples, aspects of the operations of 2010 may be performed by a CLI manager 1235 as described with reference to FIG. 12.

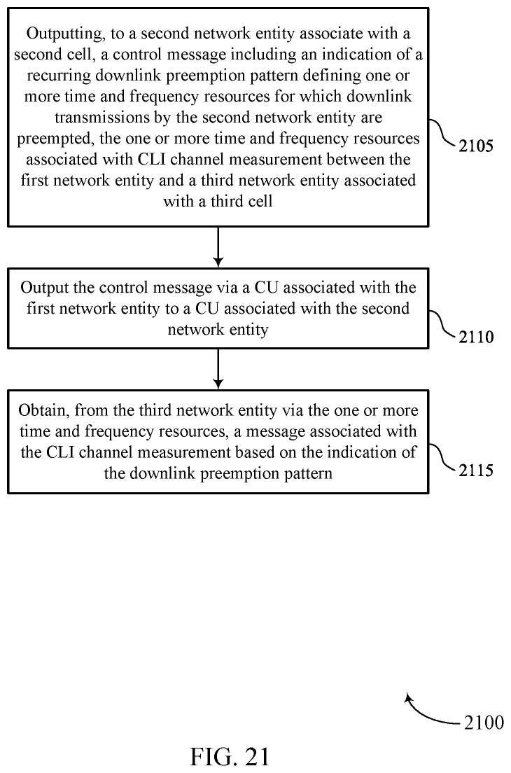

FIG. 21 shows a flowchart illustrating a method 2100 that supports downlink preemption pattern indication signaling in accordance with aspects of the present disclosure. The operations of the method 2100 may be implemented by a first network entity or its components as described herein. For example, the operations of the method 2100 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 2105, the method may include outputting, to a second network entity associated with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a third cell. The operations of 2105 may be performed in accordance with examples as disclosed herein. In some examples, aspects of the operations of 2105 may be performed by a preemption pattern manager 1225 as described with reference to FIG. 12.

At 2110, to support outputting the control message, the method may include outputting the control message via a CU associated with the first network entity to a CU associated with the second network entity. The operations of 2110 may be performed in accordance with examples as disclosed herein. In some examples, aspects of the operations of 2110 may be performed by a preemption pattern manager 1225 as described with reference to FIG. 12.

At 2115, the method may include obtaining, from the third network entity via the one or more time and frequency resources, a message associated with the CLI channel measurement based on the indication of the downlink preemption pattern. The operations of 2115 may be performed in accordance with examples as disclosed herein. In some examples, aspects of the operations of 2115 may be performed by a CLI manager 1235 as described with reference to FIG. 12.

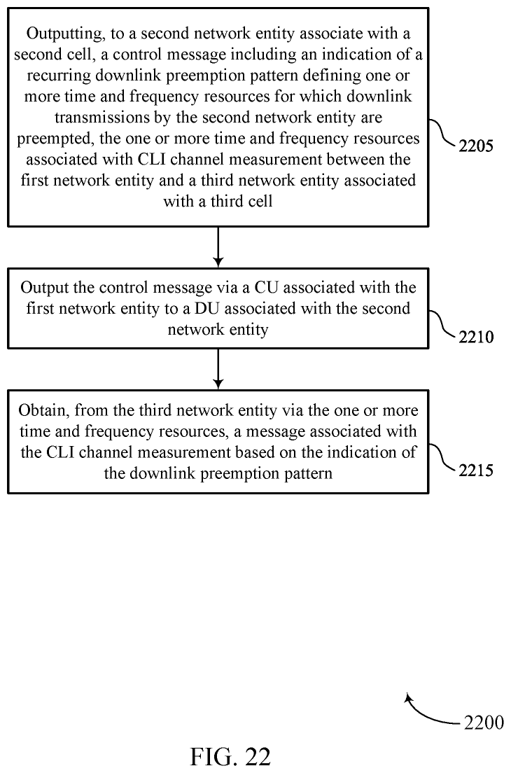

FIG. 22 shows a flowchart illustrating a method 2200 that supports downlink preemption pattern indication signaling in accordance with aspects of the present disclosure. The operations of the method 2200 may be implemented by a first network entity or its components as described herein. For example, the operations of the method 2200 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 2205, the method may include outputting, to a second network entity associated with a second cell, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a third cell. The operations of 2205 may be performed in accordance with examples as disclosed herein. In some examples, aspects of the operations of 2205 may be performed by a preemption pattern manager 1225 as described with reference to FIG. 12.

At 2210, to support outputting the control message, the method may include outputting the control message via a CU associated with the first network entity to a DU associated with the second network entity. The operations of 2210 may be performed in accordance with examples as disclosed herein. In some examples, aspects of the operations of 2210 may be performed by a preemption pattern manager 1225 as described with reference to FIG. 12.

At 2215, the method may include obtaining, from the third network entity via the one or more time and frequency resources, a message associated with the CLI channel measurement based on the indication of the downlink preemption pattern. The operations of 2215 may be performed in accordance with examples as disclosed herein. In some examples, aspects of the operations of 2215 may be performed by a CLI manager 1235 as described with reference to FIG. 12.

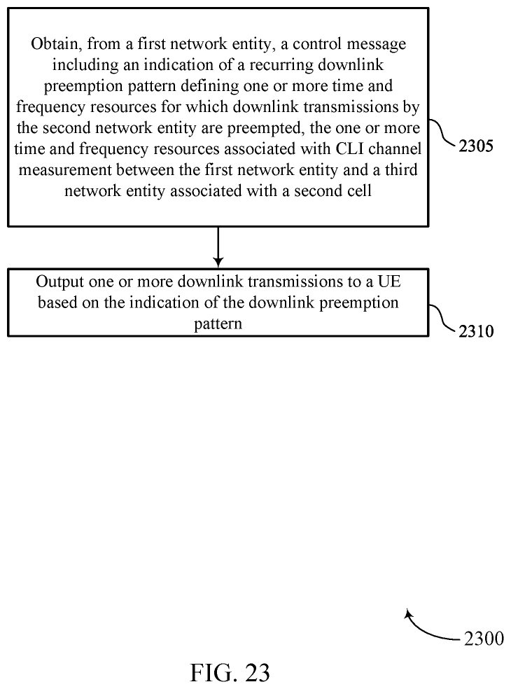

FIG. 23 shows a flowchart illustrating a method 2300 that supports downlink preemption pattern indication signaling in accordance with aspects of the present disclosure. The operations of the method 2300 may be implemented by a second network entity or its components as described herein. For example, the operations of the method 2300 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 2305, the method may include obtaining, from a first network entity, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a second cell. The operations of 2305 may be performed in accordance with examples as disclosed herein. In some examples, aspects of the operations of 2305 may be performed by a preemption pattern manager 1225 as described with reference to FIG. 12.

At 2310, the method may include outputting one or more downlink transmissions to a UE based on the indication of the downlink preemption pattern. The operations of 2310 may be performed in accordance with examples as disclosed herein. In some examples, aspects of the operations of 2310 may be performed by a downlink transmission manager 1230 as described with reference to FIG. 12.

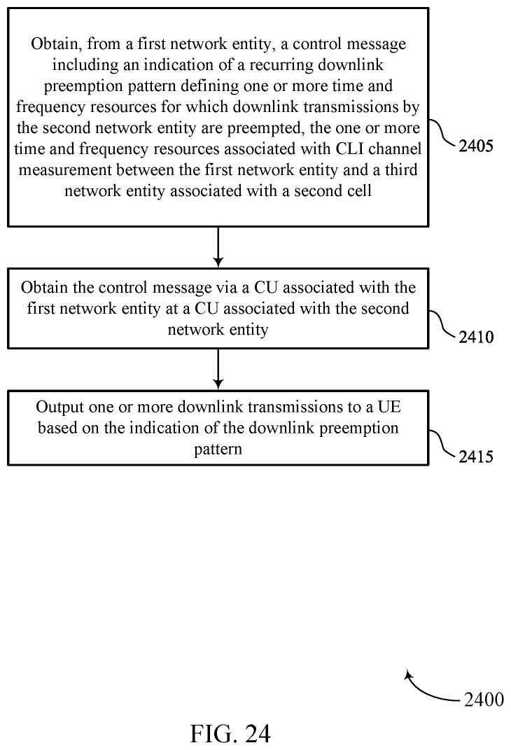

FIG. 24 shows a flowchart illustrating a method 2400 that supports downlink preemption pattern indication signaling in accordance with aspects of the present disclosure. The operations of the method 2400 may be implemented by a second network entity or its components as described herein. For example, the operations of the method 2400 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 2405, the method may include obtaining, from a first network entity, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a second cell. The operations of 2405 may be performed in accordance with examples as disclosed herein. In some examples, aspects of the operations of 2405 may be performed by a preemption pattern manager 1225 as described with reference to FIG. 12.

At 2410, to support obtaining the control message, the method may include obtaining the control message via a CU associated with the first network entity at a CU associated with the second network entity. The operations of 2410 may be performed in accordance with examples as disclosed herein. In some examples, aspects of the operations of 2410 may be performed by a preemption pattern manager 1225 as described with reference to FIG. 12.

At 2415, the method may include outputting one or more downlink transmissions to a UE based on the indication of the downlink preemption pattern. The operations of 2415 may be performed in accordance with examples as disclosed herein. In some examples, aspects of the operations of 2415 may be performed by a downlink transmission manager 1230 as described with reference to FIG. 12.

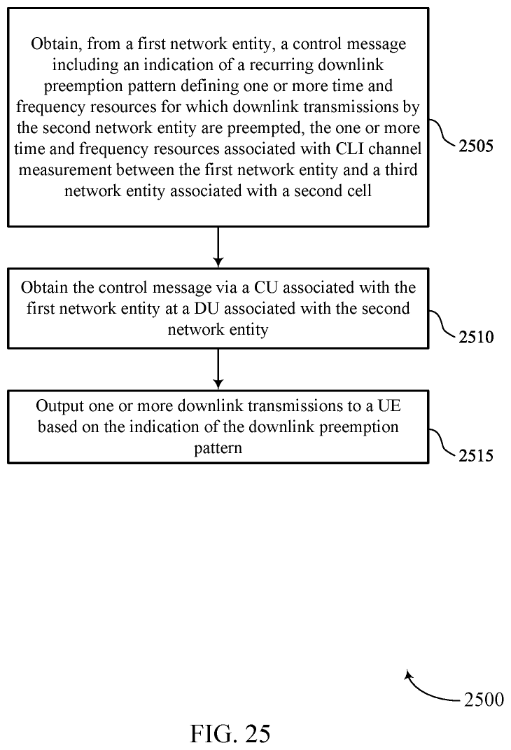

FIG. 25 shows a flowchart illustrating a method 2500 that supports downlink preemption pattern indication signaling in accordance with aspects of the present disclosure. The operations of the method 2500 may be implemented by a second network entity or its components as described herein. For example, the operations of the method 2500 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 2505, the method may include obtaining, from a first network entity, a control message including an indication of a recurring downlink preemption pattern defining one or more time and frequency resources for which downlink transmissions by the second network entity are preempted, the one or more time and frequency resources associated with CLI channel measurement between the first network entity and a third network entity associated with a second cell. The operations of 2505 may be performed in accordance with examples as disclosed herein. In some examples, aspects of the operations of 2505 may be performed by a preemption pattern manager 1225 as described with reference to FIG. 12.

At 2510, to support obtaining the control message, the method may include obtaining the control message via a CU associated with the first network entity at a DU associated with the second network entity. The operations of 2510 may be performed in accordance with examples as disclosed herein. In some examples, aspects of the operations of 2510 may be performed by a preemption pattern manager 1225 as described with reference to FIG. 12.

At 2515, the method may include outputting one or more downlink transmissions to a UE based on the indication of the downlink preemption pattern. The operations of 2515 may be performed in accordance with examples as disclosed herein. In some examples, aspects of the operations of 2515 may be performed by a downlink transmission manager 1230 as described with reference to FIG. 12.

The following provides an overview of aspects of the present disclosure:
Aspect 1: A method for wireless communication at a UE, comprising: receiving a control message comprising an indication of a recurring downlink preemption pattern defining one or more time and frequency resources for which downlink transmissions to the UE are preempted, the one or more time and frequency resources associated with CLI channel measurement between a first network entity associated with a first cell and a second network entity associated with a second cell; and receiving one or more downlink transmissions based at least in part on the indication of the downlink preemption pattern.
Aspect 2: The method of aspect 1, further comprising: receiving a second control message indicating a set of recurring downlink preemption patterns, wherein the recurring downlink preemption pattern is indicated from the set of recurring downlink preemption patterns.
Aspect 3: The method of any of aspects 1 through 2, further comprising: canceling monitoring and receiving of downlink transmissions via the one or more time and frequency resources in accordance with the downlink preemption pattern.
Aspect 4: The method of any of aspects 1 through 2, wherein receiving the one or more downlink transmissions comprises: receiving, contrary to the downlink preemption pattern, the one or more downlink transmissions via the one or more time and frequency resources based at least in part on one or more parameters associated with the downlink transmissions satisfying one or more thresholds.
Aspect 5: The method of aspect 4, wherein the one or more parameters associated with the downlink transmissions comprise a priority associated with the one or more downlink transmissions, a latency constraint associated with the one or more downlink transmissions, an MCS associated with the downlink transmissions, a transmission power associated with the downlink transmissions, or a combination thereof.
Aspect 6: The method of any of aspects 4 through 5, further comprising: receiving an indication of the one or more thresholds.
Aspect 7: The method of any of aspects 1 through 6, wherein receiving the one or more downlink transmissions comprises: receiving the one or more downlink transmissions via one or more second time and frequency resources excluded from the downlink preemption pattern.
Aspect 8: The method of any of aspects 1 through 7, wherein the recurring downlink preemption pattern applies to a set of types of downlink transmissions comprising at least SSB messages.
Aspect 9: The method of aspect 8, wherein the set of types of downlink transmissions comprises PDSCH transmissions, PDCCH transmissions, CSI-RSs, and SPS transmissions.
Aspect 10: The method of any of aspects 1 through 9, wherein the downlink preemption pattern indicates one or more subbands for which the downlink transmissions to the UE are preempted, one or more REs for which the downlink transmissions to the UE are preempted, or a frequency band comprising the one or more subbands or the one or more REs for which the downlink transmissions to the UE are preempted, the one or more time and frequency resources included in the one or more subbands, the one or more REs, or the frequency band.
Aspect 11: The method of any of aspects 1 through 10, wherein receiving the control message comprises receiving the control message via L2 signaling, L3 signaling, a MAC-CE, RRC signaling, or DCI.
Aspect 12: The method of any of aspects 1 through 11, wherein the recurring downlink preemption pattern is periodic or semi-persistent.
Aspect 13: A method for wireless communication at a first network entity associated with a first cell, comprising: outputting a control message comprising an indication of a recurring downlink preemption pattern defining one or more time and frequency resources for which downlink transmissions to a UE are preempted, the one or more time and frequency resources associated with CLI channel measurement between the first network entity and a second network entity associated with a second cell; and outputting one or more downlink transmissions to the UE based at least in part on the indication of the downlink preemption pattern.
Aspect 14: The method of aspect 13, further comprising: outputting a second control message indicating a set of recurring downlink preemption patterns, wherein the recurring downlink preemption pattern is indicated from the set of recurring downlink preemption patterns.
Aspect 15: The method of any of aspects 13 through 14, further comprising: canceling transmitting downlink signaling via the one or more time and frequency resources in accordance with the downlink preemption pattern.
Aspect 16: The method of any of aspects 13 through 14, wherein outputting the one or more downlink transmissions comprises: outputting, contrary to the downlink preemption pattern, the one or more downlink transmissions via the one or more time and frequency resources based at least in part on one or more parameters associated with the downlink transmissions satisfying one or more thresholds.
Aspect 17: The method of aspect 16, wherein the one or more parameters associated with the downlink transmissions comprise a priority associated with the one or more downlink transmissions, a latency constraint associated with the one or more downlink transmissions, an MCS associated with the downlink transmissions, a transmission power associated with the downlink transmissions, or a combination thereof.
Aspect 18: The method of any of aspects 16 through 17, further comprising: transmitting, to the UE, an indication of the one or more thresholds.
Aspect 19: The method of any of aspects 13 through 18, further comprising: obtaining, from the second network entity and via the one or more time and frequency resources, a message associated with the CLI channel measurement.
Aspect 20: The method of any of aspects 13 through 19, wherein outputting the one or more downlink transmissions comprises: outputting the one or more downlink transmissions via one or more second time and frequency resources excluded from the downlink preemption pattern.
Aspect 21: The method of any of aspects 13 through 20, wherein the recurring downlink preemption pattern applies to a set of types of downlink transmissions comprising at least SSB messages.
Aspect 22: The method of aspect 21, wherein the set of types of downlink transmissions comprises PDSCH transmissions, PDCCH transmissions, CSI-RSs, and SPS transmissions.
Aspect 23: The method of any of aspects 13 through 22, wherein the downlink preemption pattern indicates one or more subbands for which the downlink transmissions to the UE are preempted, one or more REs for which the downlink transmission to the UE are preempted, or a frequency band comprising the one or more subbands or the one or more REs for which the downlink transmissions to the UE are preempted, the one or more time and frequency resources included in the one or more subbands, the one or more REs, or the frequency band.
Aspect 24: The method of any of aspects 13 through 23, wherein outputting the control message comprises outputting the control message via L2 signaling, L3 signaling, a MAC-CE, RRC signaling, or DCI.
Aspect 25: A method for wireless communication at a first network entity associated with a first cell, comprising: outputting, to a second network entity associated with a second cell, a control message comprising an indication of a recurring downlink preemption pattern defining one or more time and frequency resources for which downlink transmissions by the second network entity are preempted, the one or more time and frequency resources associated with CLI channel measurement between the first network entity and a third network entity associated with a third cell; and obtaining, from the third network entity via the one or more time and frequency resources, a message associated with the CLI channel measurement based at least in part on the indication of the downlink preemption pattern.
Aspect 26: The method of aspect 25, wherein outputting the control message comprises: outputting the control message via a CU associated with the first network entity to a CU associated with the second network entity.
Aspect 27: The method of any of aspects 25 through 26, wherein outputting the control message comprises: outputting the control message via a CU associated with the first network entity to a DU associated with the second network entity.
Aspect 28: The method of any of aspects 25 through 27, wherein outputting the control message comprises: outputting the control message to the second network entity via OTA signaling.
Aspect 29: The method of any of aspects 25 through 28, wherein the recurring downlink preemption pattern applies to a set of types of downlink transmissions comprising at least SSB messages.
Aspect 30: The method of aspect 29, wherein the set of types of downlink transmissions comprises PDSCH transmissions, PDCCH transmissions, CSI-RSs, and SPS transmissions.
Aspect 31: The method of any of aspects 25 through 30, wherein the downlink preemption pattern indicates one or more subbands for which the downlink transmissions to a UE are preempted, one or more REs for which the downlink transmissions to the UE are preempted, or a frequency band comprising the one or more subbands or the one or more REs for which the downlink transmissions to the UE are preempted, the one or more time and frequency resources included in the one or more subbands, the one or more REs, or the frequency band.
Aspect 32: The method of any of aspects 25 through 31, wherein the recurring downlink preemption pattern is periodic or semi-persistent.
Aspect 33: A method for wireless communication at a second network entity, comprising: obtaining, from a first network entity, a control message comprising an indication of a recurring downlink preemption pattern defining one or more time and frequency resources for which downlink transmissions by the second network entity are preempted, the one or more time and frequency resources associated with CLI channel measurement between the first network entity and a third network entity associated with a second cell; and outputting one or more downlink transmissions to a UE based at least in part on the indication of the downlink preemption pattern.
Aspect 34: The method of aspect 33, wherein obtaining the control message comprises: obtaining the control message via a CU associated with the first network entity at a CU associated with the second network entity.
Aspect 35: The method of any of aspects 33 through 34, wherein obtaining the control message comprises: obtaining the control message via a CU associated with the first network entity at a DU associated with the second network entity.
Aspect 36: The method of any of aspects 33 through 35, wherein obtaining the control message comprises: obtaining the control message from the first network entity via OTA signaling.
Aspect 37: The method of any of aspects 33 through 36, wherein the recurring downlink preemption pattern applies to a set of types of downlink transmissions comprising at least SSB messages.
Aspect 38: The method of aspect 37, wherein the set of types of downlink transmissions comprises PDSCH transmissions, PDCCH transmissions, CSI-RSs, and SPS transmissions.
Aspect 39: The method of any of aspects 33 through 38, wherein the downlink preemption pattern indicates one or more subbands for which the downlink transmissions to the UE are preempted, one or more REs for which the downlink transmissions to the UE are preempted, or a frequency band comprising the one or more subbands or the one or more REs for which the downlink transmissions to the UE are preempted, the one or more time and frequency resources included in the one or more subbands, the one or more REs, or the frequency band.
Aspect 40: The method of any of aspects 33 through 39, wherein outputting the one or more downlink transmissions comprises: outputting, contrary to the downlink preemption pattern, the one or more downlink transmissions via the one or more time and frequency resources based at least in part on one or more parameters associated with the downlink transmissions satisfying one or more thresholds.
Aspect 41: The method of aspect 40, wherein the one or more parameters associated with the downlink transmissions comprise a priority associated with the one or more downlink transmissions, a latency constraint associated with the one or more downlink transmissions, an MCS associated with the downlink transmissions, a transmission power associated with the downlink transmissions, or a combination thereof.
Aspect 42: The method of any of aspects 40 through 41, further comprising: receiving, from the first network entity, an indication of the one or more thresholds.
Aspect 43: The method of any of aspects 33 through 42, wherein the recurring downlink preemption pattern is periodic or semi-persistent.
Aspect 44: The method of any of aspects 33 through 43, wherein outputting the one or more downlink transmissions comprises: outputting the one or more downlink transmissions via one or more second time and frequency resources excluded from the downlink preemption pattern.
Aspect 45: The method of any of aspects 33 through 39 and 42 through 44, further comprising: canceling transmitting downlink signaling via the one or more time and frequency resources in accordance with the downlink preemption pattern.
Aspect 46: The method of any of aspects 33 through 45, further comprising: transmitting, to the UE, an indication of the downlink preemption pattern.
Aspect 47: An apparatus for wireless communication at a UE, comprising at least one processor; and memory coupled (e.g., operatively, communicatively, functionally, electronically, or electrically) with the at least one processor, the memory storing instructions executable by the at least one processor (e.g., directly, indirectly, after pre-processing, without pre-processing) to cause the UE to perform a method of any of aspects 1 through 12.
Aspect 48: An apparatus for wireless communication at a UE, comprising at least one means for performing a method of any of aspects 1 through 12.
Aspect 49: A non-transitory computer-readable medium storing code for wireless communication at a UE, the code comprising instructions executable by at least one processor (e.g., directly, indirectly, after pre-processing, without pre-processing) to perform a method of any of aspects 1 through 12.
Aspect 50: An apparatus for wireless communication at a first network entity associated with a first cell, comprising at least one processor; and memory coupled (e.g., operatively, communicatively, functionally, electronically, or electrically) with the at least one processor, the memory storing instructions executable by the at least one processor (e.g., directly, indirectly, after pre-processing, without pre-processing) to cause the first network entity to perform a method of any of aspects 13 through 24.
Aspect 51: An apparatus for wireless communication at a first network entity associated with a first cell, comprising at least one means for performing a method of any of aspects 13 through 24.
Aspect 52: A non-transitory computer-readable medium storing code for wireless communication at a first network entity associated with a first cell, the code comprising instructions executable by at least one processor (e.g., directly, indirectly, after pre-processing, without pre-processing) to perform a method of any of aspects 13 through 24.
Aspect 53: An apparatus for wireless communication at a first network entity associated with a first cell, comprising at least one processor; and memory coupled (e.g., operatively, communicatively, functionally, electronically, or electrically) with the at least one processor, the memory storing instructions executable by the at least one processor (e.g., directly, indirectly, after pre-processing, without pre-processing) to cause the first network entity to perform a method of any of aspects 25 through 32.
Aspect 54: An apparatus for wireless communication at a first network entity associated with a first cell, comprising at least one means for performing a method of any of aspects 25 through 32.
Aspect 55: A non-transitory computer-readable medium storing code for wireless communication at a first network entity associated with a first cell, the code comprising instructions executable by at least one processor (e.g., directly, indirectly, after pre-processing, without pre-processing) to perform a method of any of aspects 25 through 32.
Aspect 56: An apparatus for wireless communication at a second network entity, comprising at least one processor; and memory coupled (e.g., operatively, communicatively, functionally, electronically, or electrically) with the at least one processor, the memory storing instructions executable by the at least one processor (e.g., directly, indirectly, after pre-processing, without pre-processing) to cause the second network entity to perform a method of any of aspects 33 through 46.
Aspect 57: An apparatus for wireless communication at a second network entity, comprising at least one means for performing a method of any of aspects 33 through 46.
Aspect 58: A non-transitory computer-readable medium storing code for wireless communication at a second network entity, the code comprising instructions executable by at least one processor (e.g., directly, indirectly, after pre-processing, without pre-processing) to perform a method of any of aspects 33 through 46.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C, e.g., means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled with the at least one processor, the memory storing instructions executable by the at least one processor to cause the UE to:
receive a control message comprising an indication of a recurring downlink preemption pattern defining one or more time and frequency resources for which downlink transmissions to the UE are preempted, the one or more time and frequency resources associated with cross link interference channel measurement between a first network entity associated with a first cell and a second network entity associated with a second cell; and
receive one or more downlink transmissions based at least in part on the indication of the downlink preemption pattern.

2. The apparatus of claim 1, wherein the instructions are further executable by the at least one processor to cause the UE to:
receive a second control message indicating a set of recurring downlink preemption patterns, wherein the recurring downlink preemption pattern is indicated from the set of recurring downlink preemption patterns.

3. The apparatus of claim 1, wherein the instructions are further executable by the at least one processor to cause the UE to:
cancel monitoring and receiving of downlink transmissions via the one or more time and frequency resources in accordance with the downlink preemption pattern; and
receive the one or more downlink transmissions via one or more second time and frequency resources excluded from the downlink preemption pattern.

4. The apparatus of claim 1, wherein the instructions to receive the one or more downlink transmissions are executable by the at least one processor to cause the UE to:
receive, contrary to the downlink preemption pattern, the one or more downlink transmissions via the one or more time and frequency resources based at least in part on one or more parameters associated with the downlink transmissions satisfying one or more thresholds.

5. The apparatus of claim 4, wherein the one or more parameters associated with the downlink transmissions comprise a priority associated with the one or more downlink transmissions, a latency constraint associated with the one or more downlink transmissions, a modulation and coding scheme associated with the downlink transmissions, a transmission power associated with the downlink transmissions, or a combination thereof.

6. The apparatus of claim 4, wherein the instructions are further executable by the at least one processor to cause the UE to:
receive an indication of the one or more thresholds.

7. The apparatus of claim 1, wherein the recurring downlink preemption pattern applies to a set of types of downlink transmissions comprising one or more of synchronization signal block (SSB) messages, physical downlink shared channel transmissions, physical downlink control channel transmissions, channel state information reference signals, and semi-persistent scheduling transmissions.

8. The apparatus of claim 1, wherein the downlink preemption pattern indicates one or more subbands for which the downlink transmissions to the UE are preempted, one or more resource elements for which the downlink transmissions to the UE are preempted, or a frequency band comprising the one or more subbands or the one or more resource elements for which the downlink transmissions to the UE are preempted, the one or more time and frequency resources included in the one or more subbands, the one or more resource elements, or the frequency band.

9. The apparatus of claim 1, wherein receiving the control message comprises receiving the control message via layer 2 signaling, layer 3 signaling, a medium access control-control element, radio resource control signaling, or downlink control information.

10. The apparatus of claim 1, wherein the recurring downlink preemption pattern is periodic or semi-persistent.

11. An apparatus for wireless communication at a first network entity associated with a first cell, comprising:
at least one processor; and
memory coupled with the at least one processor, the memory storing instructions executable by the at least one processor to cause the first network entity to:
output a control message comprising an indication of a recurring downlink preemption pattern defining one or more time and frequency resources for which downlink transmissions to a user equipment (UE) are preempted, the one or more time and frequency resources associated with cross link interference channel measurement between the first network entity and a second network entity associated with a second cell; and
output one or more downlink transmissions to the UE based at least in part on the indication of the downlink preemption pattern.

12. The apparatus of claim 11, wherein the instructions are further executable by the at least one processor to cause the first network entity to:
output a second control message indicating a set of recurring downlink preemption patterns, wherein the recurring downlink preemption pattern is indicated from the set of recurring downlink preemption patterns.

13. The apparatus of claim 11, wherein the instructions are further executable by the at least one processor to cause the first network entity to:
cancel transmitting downlink signaling via the one or more time and frequency resources in accordance with the downlink preemption pattern; and
output the one or more downlink transmissions via one or more second time and frequency resources excluded from the downlink preemption pattern.

14. The apparatus of claim 11, wherein the instructions to output the one or more downlink transmissions are executable by the at least one processor to cause the first network entity to:
output, contrary to the downlink preemption pattern, the one or more downlink transmissions via the one or more time and frequency resources based at least in part on one or more parameters associated with the downlink transmissions satisfying one or more thresholds.

15. The apparatus of claim 11, wherein the instructions are further executable by the at least one processor to cause the first network entity to:
obtain, from the second network entity and via the one or more time and frequency resources, a message associated with the cross link interference channel measurement.

16. The apparatus of claim 11, wherein the recurring downlink preemption pattern applies to a set of types of downlink transmissions comprising one or more of synchronization signal block (SSB) messages, physical downlink shared channel transmissions, physical downlink control channel transmissions, channel state information reference signals, and semi-persistent scheduling transmissions.

17. An apparatus for wireless communication at a first network entity associated with a first cell, comprising:
at least one processor; and
memory coupled with the at least one processor, the memory storing instructions executable by the at least one processor to cause the first network entity to:
output, to a second network entity associated with a second cell, a control message comprising an indication of a recurring downlink preemption pattern defining one or more time and frequency resources for which downlink transmissions by the second network entity are preempted, the one or more time and frequency resources associated with cross link interference channel measurement between the first network entity and a third network entity associated with a third cell; and
obtain, from the third network entity via the one or more time and frequency resources, a message associated with the cross link interference channel measurement based at least in part on the indication of the downlink preemption pattern.

18. The apparatus of claim 17, wherein the instructions to output the control message are executable by the at least one processor to cause the first network entity to:
output the control message via a central unit associated with the first network entity to a central unit or a distributed unit associated with the second network entity.

19. The apparatus of claim 17, wherein the instructions to output the control message are executable by the at least one processor to cause the first network entity to:
output the control message to the second network entity via over the air signaling.

20. The apparatus of claim 17, wherein the recurring downlink preemption pattern applies to a set of types of downlink transmissions comprising one or more of synchronization signal block (SSB) messages, physical downlink shared channel transmissions, physical downlink control channel transmissions, channel state information reference signals, and semi-persistent scheduling transmissions.

21. The apparatus of claim 17, wherein the downlink preemption pattern indicates one or more subbands for which the downlink transmissions to a user equipment (UE) are preempted, one or more resource elements for which the downlink transmissions to the UE are preempted, or a frequency band comprising the one or more subbands or the one or more resource elements for which the downlink transmissions to the UE are preempted, the one or more time and frequency resources included in the one or more subbands, the one or more resource elements, or the frequency band.

22. An apparatus for wireless communication at a second network entity, comprising:
at least one processor; and
memory coupled with the at least one processor, the memory storing instructions executable by the at least one processor to cause the second network entity to:
obtain, from a first network entity, a control message comprising an indication of a recurring downlink preemption pattern defining one or more time and frequency resources for which downlink transmissions by the second network entity are preempted, the one or more time and frequency resources associated with cross link interference channel measurement between the first network entity and a third network entity associated with a second cell; and
output one or more downlink transmissions to a user equipment (UE) based at least in part on the indication of the downlink preemption pattern.

23. The apparatus of claim 22, wherein the instructions to obtain the control message are executable by the at least one processor to cause the second network entity to:
obtain the control message via a central unit associated with the first network entity at a central unit or a distributed unit associated with the second network entity or via over the air signaling.

24. The apparatus of claim 22, wherein the recurring downlink preemption pattern applies to a set of types of downlink transmissions comprising one or more of synchronization signal block (SSB) messages, physical downlink shared channel transmissions, physical downlink control channel transmissions, channel state information reference signals, and semi-persistent scheduling transmissions.

25. The apparatus of claim 22, wherein the downlink preemption pattern indicates one or more subbands for which the downlink transmissions to the UE are preempted, one or more resource elements for which the downlink transmissions to the UE are preempted, or a frequency band comprising the one or more subbands or the one or more resource elements for which the downlink transmissions to the UE are preempted, the one or more time and frequency resources included in the one or more subbands, the one or more resource elements, or the frequency band.

26. The apparatus of claim 22, wherein the instructions to output the one or more downlink transmissions are executable by the at least one processor to cause the second network entity to:
output, contrary to the downlink preemption pattern, the one or more downlink transmissions via the one or more time and frequency resources based at least in part on one or more parameters associated with the downlink transmissions satisfying one or more thresholds.

27. The apparatus of claim 26, wherein the one or more parameters associated with the downlink transmissions comprise a priority associated with the one or more downlink transmissions, a latency constraint associated with the one or more downlink transmissions, a modulation and coding scheme associated with the downlink transmissions, a transmission power associated with the downlink transmissions, or a combination thereof.

28. The apparatus of claim 26, wherein the instructions are further executable by the at least one processor to cause the second network entity to:
receive, from the first network entity, an indication of the one or more thresholds.

29. The apparatus of claim 22, wherein the instructions to output the one or more downlink transmissions are executable by the at least one processor to cause the second network entity to:
cancel transmitting downlink signaling via the one or more time and frequency resources in accordance with the downlink preemption pattern; and
output the one or more downlink transmissions via one or more second time and frequency resources excluded from the downlink preemption pattern.

30. The apparatus of claim 22, wherein the instructions are further executable by the at least one processor to cause the second network entity to:
transmit, to the UE, an indication of the downlink preemption pattern.
